(19) United States
(12) Patent Application Publication
(10) Pub. No.: US 2026/0037906 A1
(43) Pub. Date: Feb. 5, 2026

(54) COMPUTER-BASED SYSTEMS AND METHODS FOR AUTOMATED AIRCRAFT CARGO LOAD PLANNING AND OPTIMAL SHIPPING CONFIGURATIONS

(71) Applicant: American Airlines, Inc., Fort Worth, TX (US)

(72) Inventors: June MA, Colleyville, TX (US); Xin LIU, Colleyville, TX (US); Cumhur GELOGULLARI, Coppell, TX (US); Elzbieta KIZER, Colleyville, TX (US); Korina TRINH, Forth Worth, TX (US); Miheeth GALA, Euless, TX (US); Praveen DANDA, Farmers Branch, TX (US); Michael COSTELLO, Euless, TX (US); Omar MATOS, Colleyville, TX (US); Roman SHEVCHUK, Grapevine, TX (US); Louis PREBEVSEK, Wylie, TX (US); Na DENG, Keller, TX (US)

(21) Appl. No.: 18/789,330

(22) Filed: Jul. 30, 2024

(51) Int. Cl. G06Q 10/083

(52) U.S. Cl. CPC G06Q 10/083

(57) ABSTRACT

An example method includes receiving first data indicative of a plurality of predetermined configurations for loading cargo into a compartment of a cargo hold of an aircraft. Each of the plurality of predetermined configurations includes a possible layout of a plurality of unit load devices. The method further includes receiving second data indicative of shipments available for transportation in the aircraft. The method further includes determining a plurality of possible shipping configurations from the plurality of predetermined configurations, each one of the plurality of possible shipping configurations comprising an assignment of the shipments into or as one of the plurality of unit load devices, and a location of each of the plurality of unit load devices within the cargo hold of the aircraft. The method further includes determining one of the plurality of possible shipping configurations that satisfies a rule.

### FIELD OF TECHNOLOGY

The present disclosure generally relates to improved computer-based platforms/systems, improved computing devices/components and/or improved computing objects configured for one or more novel technological applications of automated aircraft cargo load planning and unit load device configurations, including cargo load planning for aircraft while maintaining aircraft weight balance and optimizing cargo assignments.

### SUMMARY

In various embodiments, an exemplary technically improved computer-based method includes at least receiving, by a processor of a computing device, first data indicative of a plurality of predetermined configurations for loading cargo into a compartment of a cargo hold of an aircraft. Each of the plurality of predetermined configurations includes a possible layout of a plurality of unit load devices. The plurality of unit load devices include at least two different types of unit load devices. The method further includes receiving, by the processor, second data indicative of a plurality of shipments available for transportation in the aircraft. Each one of the plurality of shipments is pre-packaged into a first unit load device type of the at least two different types of unit load devices, or configured for placement into a second unit load device type of the at least two different types of unit load devices. The method further includes determining, by the processor, a plurality of possible shipping configurations from the plurality of predetermined configurations. Each one of the plurality of possible shipping configurations includes a recommended assignment of each of the plurality of shipments into or as one of the plurality of unit load devices, and a recommended location of each of the plurality of unit load devices within the cargo hold of the aircraft according to the possible layout of each of the plurality of possible shipping configurations. The method further includes determining, by the processor based on at least one rule related to weight balancing of the aircraft, one of the plurality of possible shipping configurations that satisfies the at least one rule.

In various embodiments, an exemplary technically improved non-transitory computer readable medium having instructions stored thereon that, upon execution by a computing device, cause the computing device to perform operations includes receiving first data indicative of a plurality of predetermined configurations for loading cargo into a compartment of a cargo hold of an aircraft. Each of the plurality of predetermined configurations includes a possible layout of a plurality of unit load devices. The plurality of unit load devices include at least two different types of unit load devices. The instructions further cause the computing device to perform operations include receiving second data indicative of a plurality of shipments available for transportation in the aircraft. Each one of the plurality of shipments is pre-packaged into a first unit load device type of the at least two different types of unit load devices, or configured for placement into a second unit load device type of the at least two different types of unit load devices. The instructions further cause the computing device to perform operations include determining a plurality of possible shipping configurations from the plurality of predetermined configurations. Each one of the plurality of possible shipping configurations includes a recommended assignment of each of the plurality of shipments into or as one of the plurality of unit load devices, and a recommended location of each of the plurality of unit load devices within the cargo hold of the aircraft according to the possible layout of each of the plurality of possible shipping configurations. The instructions further cause the computing device to perform operations include determining, based on at least one rule related to weight balancing of the aircraft, one of the plurality of possible shipping configurations that satisfies the at least one rule.

In various embodiments, the present disclosure provides an exemplary technically improved computer-based system that includes at least the following components of a memory and at least one processor coupled to the memory. The processor is configured to receive first data indicative of a plurality of predetermined configurations for loading cargo into a compartment of a cargo hold of an aircraft. Each of the plurality of predetermined configurations includes a possible layout of a plurality of unit load devices. The processor is further configured to receive second data indicative of a plurality of shipments available for transportation in the aircraft. Each one of the plurality of shipments is pre-packaged into one of the plurality of unit load devices, or configured for placement into one of the plurality of unit load devices. The processor is further configured to determine a plurality of possible shipping configurations from the plurality of predetermined configurations. Each one of the plurality of possible shipping configurations includes a recommended assignment of each of the plurality of shipments into one of the plurality of unit load devices, and a recommended location of each of the plurality of unit load devices within the cargo hold of the aircraft according to the possible layout of each of the plurality of possible shipping configurations. The processor is further configured to determine, based on at least one rule related to weight balancing of the aircraft, one of the plurality of possible shipping configurations that satisfies the at least one rule.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein, including in the various drawings and figures, are not to be interpreted as limiting, but merely as a representative basis for teaching one skilled in the art to variously employ one or more illustrative embodiments.

FIG. 1 is a block diagram illustrating a system for performing cargo load planning for an aircraft in accordance with one or more embodiments of the present disclosure.

FIG. 2 is a diagram illustrating a process for performing cargo load planning for an aircraft in accordance with one or more embodiments of the present disclosure.

FIG. 3 is a block diagram illustrating an example cargo compartment configuration of an aircraft in accordance with one or more embodiments of the present disclosure.

FIG. 4 is a block diagram illustrating a first example plan for loading unit load devices (ULDs) in the example cargo compartment configuration of FIG. 3 in accordance with one or more embodiments of the present disclosure.

FIG. 5 is a diagram illustrating a first example data table representing the first example plan for loading the unit load devices (ULDs) of FIG. 4 in accordance with one or more embodiments of the present disclosure.

FIG. 6 is a block diagram illustrating a second example plan for loading unit load devices (ULDs) in the example cargo compartment configuration of FIG. 3 in accordance with one or more embodiments of the present disclosure.

FIG. 7 is a diagram illustrating a second example data table representing the first example plan for loading the unit load devices (ULDs) of FIG. 6 in accordance with one or more embodiments of the present disclosure.

FIG. 8 is a diagram illustrating a process running an optimization model for performing cargo load planning for an aircraft in accordance with one or more embodiments of the present disclosure.

FIG. 9 is a diagram illustrating a process for performing cargo load planning for an aircraft and subsequently loading the aircraft with cargo in accordance with one or more embodiments of the present disclosure.

FIG. 10 is a block diagram illustrating a computerized user interface for entering flight information in accordance with one or more embodiments of the present disclosure.

FIG. 11 is a block diagram illustrating a computerized user interface for performing and optimizing cargo load planning for an aircraft in accordance with one or more embodiments of the present disclosure.

FIG. 12 is a block diagram illustrating a computerized user interface showing optimization results for cargo load planning for a given aircraft flight and a unit load device (ULD) summary in accordance with one or more embodiments of the present disclosure.

FIG. 13 is a block diagram illustrating a computerized user interface showing detail of cargo shipments to be loaded into an example unit load device (ULD) for a given aircraft flight in accordance with one or more embodiments of the present disclosure.

FIG. 14 is a block diagram illustrating a computerized user interface showing a position summary for where unit load devices (ULDs) are to be loaded for an example aircraft flight in accordance with one or more embodiments of the present disclosure.

FIG. 15 is a block diagram illustrating a computerized user interface showing all cargo shipments to be loaded into unit load devices (ULDs) for a given aircraft flight in accordance with one or more embodiments of the present disclosure.

FIG. 16 is a block diagram illustrating a computerized user interface for showing any cargo shipments to be offloaded or not included in unit load devices (ULDs) for a given aircraft flight in accordance with one or more embodiments of the present disclosure.

FIG. 17 is a block diagram illustrating a computer-based system and platform in accordance with one or more embodiments of the present disclosure.

FIG. 18 is a block diagram illustrating another computer-based system and platform in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Described herein are methods, systems, computer readable media, etc. for a process for performing cargo load planning for an aircraft. The various embodiments herein specifically relate to optimizing a cargo load planning for various aircraft, such as passenger aircraft, with a series of optimization models that may be implemented (e.g., in a particular order, in no particular order, simultaneously, etc.) to determine a best or recommended aircraft cargo configuration for unit load devices (ULDs) and shipment allocation in each of the ULDs for shipments booked on a given flight so that a maximum number of shipments may be loaded onto a given flight while also maintaining the aircraft weigh balance.

For example, a commercial airline may allocate cargo to certain flights to move cargo from one city or location to another. The cargo may be moved on behalf of passengers of the airline (e.g., baggage of passengers), on behalf of the airline itself, and/or on behalf of third parties that have cargo the third parties desire to be moved from one location/city to another. Such cargo may be associated with or assigned to specific flights based on the various factors (e.g., a passenger's bag may be assigned to the flight that the passenger is on, a third party's cargo may be assigned to a flight that matches a schedule and desired origin/destination of the cargo to be transported). As such, cargo shipments may be booked for or otherwise associated with a specific flight. In other words, the cargo associated with a specific flight may be available for transportation in a specific aircraft for a particular flight of that aircraft.

A few hours before the time a particular flight is scheduled to depart (e.g., a scheduled departure time), a load worker of an airline may sort various pieces of cargo associated with that flight into different unit load devices (ULDs). ULDs are containers or other devices in which one or more piece of cargo may be stored. In this way, passenger bags or other cargo may be stored in a ULD, and then the ULD may be loaded into a cargo hold of an aircraft for a flight. Cargo may also be pre-packaged in or as a ULD. For example, a ULD may be received from a third-party that has already been packed or packaged into a ULD or as a ULD. ULDs may therefore be containers in which cargo may be placed or may be pallets or other configurations of cargo that are nonetheless configured to be secured in and stored in an aircraft cargo hold.

Airline workers may view all the cargo available for a particular flight and determine how to load that cargo into a plane in a particular ULD configuration (e.g., how the ULDs are placed within a cargo hold of a given aircraft). However, described herein are improved technological methods for determining an optimized ULD configuration for a particular flight from a plurality of possible ULD configurations, where the systems, methods, and computer readable media herein are configured to determine first what ULD configurations are possible from a total number of ULD configurations, and then determining which of those possible ULD configurations to recommend as an optimal ULD configuration for a flight based on various constraints or rules for loading the cargo into a given flight. For example, one constraint or rule may be that passenger bags must be placed in a tail end of an aircraft and near a door for easy access.

As such, the systems, methods, and computer readable media described herein may, prior to a scheduled departure time of a flight, use such constraints and rules along with data relating to the type and weight of the planned ULDs for a flight once they are built (e.g., once cargo is placed into container-type ULDs, once other pre-packed ULDs are known/available), passenger weight data, fuel weight data, etc. to determine an optimal ULD configuration from a number of possible ULD configurations for a given flight and planned cargo for that flight, where the number of possible ULD configurations is a subset of all possible ULD configurations that may be possible for a given airplane cargo hold. All of these rules, constraints, and data may be used to determine the optimal ULD configuration and ensure that the plan for assigning cargo into various ULDs and where to load the ULDs into the aircraft yield an aircraft with the proper aircraft weight balance. The systems, methods, and computer readable media described herein therefore provide for improved technological embodiments for load planning cargo for an aircraft, which may advantageously reduce the amount of cargo and/or ULDs that is excluded or offloaded from an aircraft despite being scheduled to be on the aircraft for a given flight.

Further, the embodiments herein may advantageously determine the optimal loading of cargo into particular ULDs before cargo is actually placed into any ULDs, which is advantageous over packing cargo into ULDs and then determining weight balance calculations, as packing cargo before checking weight balance can lead to offloading of cargo, failing to get a maximum amount of possible cargo onto a given flight, etc. due to weight imbalances caused by already filled ULDs. The systems, methods, and computer readable Media described herein therefore provide for improved technological embodiments for load planning cargo for an aircraft because the embodiments may use known or estimated data about the number/weight of passengers and/or the number/weight of passengers' baggage-data that may not be precisely known for a given commercial flight until right at the time of takeoff.

As such, various embodiments described herein may use various instructions stored on a computer readable media, where those instructions are executable by a processor to determine how to build ULDs for a given flight while simultaneously checking load balance to make sure those built ULDs meet any weight balance rules at takeoff and at landing as well as any other desired constraints or rules. The embodiments therefore advantageously incorporate weight balance calculations directly into the ULD building process, performing weight balancing relating to both location and weight of individual ULDs, as well as other weight factors such as passenger weight by cabin and fuel on board.

Further described herein are graphical user interfaces for computer displays and user interface elements with which a user may interact, such that a user may, for an example particular flight, select and view real-time shipment data from a cargo database and real-time flight data, generate and view a forecast of a number of passengers checked bags, generate and view a forecast of an amount of release fuel, and/or run a process to provide a best solution (e.g., a recommended ULD configuration) while meeting various rules (where rules may also be referred to herein as constraints).

Example processes for determining a recommended ULD configuration for a particular flight may consider, for example, any combination of the following rules, constraints, or factors as further described herein: a forecasted number of checked bags, a forecasted amount of release fuel, any physical restrictions of ULDs acceptable for a given aircraft configuration (e.g., a configuration for a specific aircraft model made by a particular manufacturer), physical restrictions of shipments being loaded to ULDs, whether a piece of cargo is considered a higher priority shipment than other pieces of cargo, a number of ULDs available for use for a given flight in which to store and secure cargo, whether pieces of cargo put into a given ULD are within a weight limit and/or volume limit of the ULD, whether total weight in a given aircraft cargo hold compartment is within that compartment's weight limits, any pre-build ULDs as well as pre-built ULDs associated weight and/or a pre-determined location or locations that such a pre-built ULD is configured to be placed or secured within a given cargo compartment, a rule that passenger checked bags must be placed close to a front door of an aircraft and loaded into a particular type of ULD, that items related to aircraft maintenance (e.g., parts that need to be shipped to another airport for repair or maintenance of another plane) may be assigned a higher priority than other cargo/shipments, that cargo with higher values and/or higher prices charged for shipping the cargo may be assigned higher priority than low value or low priced shipments/cargo, that pieces of cargo from a same customer or part of a same shipment order or that are otherwise related should go in a same ULD, an aircraft weight balance at the time of takeoff, an aircraft weight balance at the time of landing, a center of gravity for zero fuel weight (ZFW) must be within a certain range, a center of gravity for takeoff weight (TOW) must be within a certain range, or any other factor. ZFW refers to a weight of an aircraft (e.g., an aircraft as it will be loaded with cargo, passengers, etc.) when there is no or zero fuel in the aircraft. TOW refers to a weight of an aircraft at the time of takeoff (e.g., an aircraft as it will be loaded with fuel, cargo, passengers, etc. at takeoff), which may include a full load of fuel or a different amount of fuel less than full that the aircraft will have at the time of takeoff.

As such, the embodiments herein provide real time cargo load planning, including determining where to place ULDs on an aircraft, what cargo or shipments to place into those ULDs, meeting safety rules (e.g., weight balance and center of gravity rules and restrictions for a given aircraft at TOW and ZFW), and meeting any other rules or constraints for loading cargo. As such, the embodiments herein provide for solutions that efficiently load cargo while still meeting aircraft weight balance restrictions so that an aircraft can take off and land safely, including by taking into account weight balancing factors that involve aerodynamics and complex relationships between the location and weight of individual ULDs as well as other weight factors such as passenger weight by cabin and fuel on board. As such, aircraft weight balance restrictions and weight/location of shipments placed on an aircraft may be interdependent, and all such factors are advantageously considered by the embodiments described herein.

Further described herein are embodiments for particular arrangements for graphical user interfaces and computerized displayed that represent a technical solution to technical problems. For example, the embodiments herein provide for outputting onto a computerized display a graphical output showing exactly how ULDs should be loaded into an aircraft for a given flight, exactly what shipments or cargo to place in each ULD for a given flight, etc. Aircraft operators face a problem where employees may load cargo into ULDs and weight balance calculations may be performed after the cargo or shipments is already sorted into and loaded into ULDs. However, the computerized displays and user interfaces described and shown herein represent technical solutions to the problem of both how to load the ULDs into an aircraft, but also how to load individual cargo/shipments into a ULD. The technical aspects of the displays provide solutions that make it possible for ULDs to advantageously be loaded with individual cargo/shipments after weight balance calculations are performed rather than before, with still enough time to then load the ULDs into an aircraft before a scheduled flight time. In addition, such embodiments further provide for more efficient loading of cargo, such that more cargo may be carried on flights as the cargo may be more efficiently loaded into the ULDs and the ULDs may be more efficiently placed within the aircraft using the technical systems, methods, computer readable media, and computerized displays described and shown herein. The embodiments described herein therefore represent a significant technical improvement over methods where cargo was loaded into ULDs prior to performing weight balance calculations. Furthermore, the technical improvements herein include the ability to consider different weight balance arrangements based on what cargo is placed in particular ULDs (and therefore consider placing different cargo in each ULD), whereas previous methods may have considered a ULD to be static once loaded with cargo/shipments. Such embodiments as described herein therefore provide for a technical improvement of more granular and flexible weight balance calculations that allow for more cargo to be loaded on an aircraft than other methods.

Such embodiments as described herein further offer the technical improvement of being able to accept and/or consider more last minute changes, such as changes to passenger weight, passenger baggage weight, additional last minute shipments or cargo that a customer or airline desires to add to a flight. In other words, the embodiments herein provide increased flexibility to add, remove, and/or reconfigure cargo/shipments for a given flight.

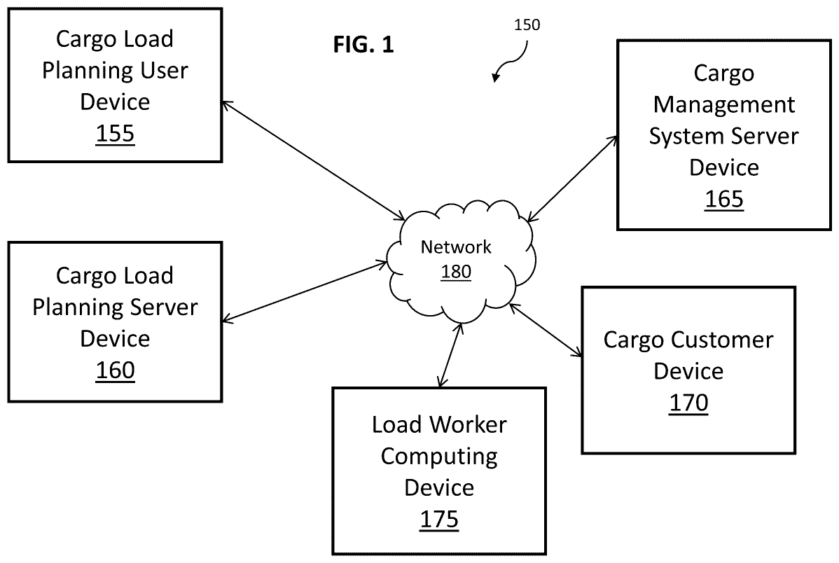

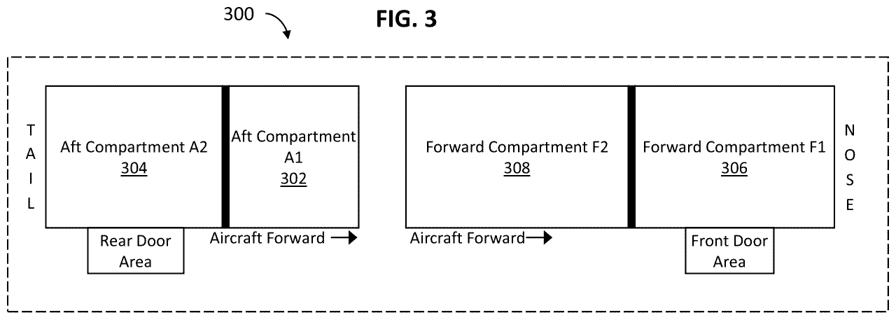

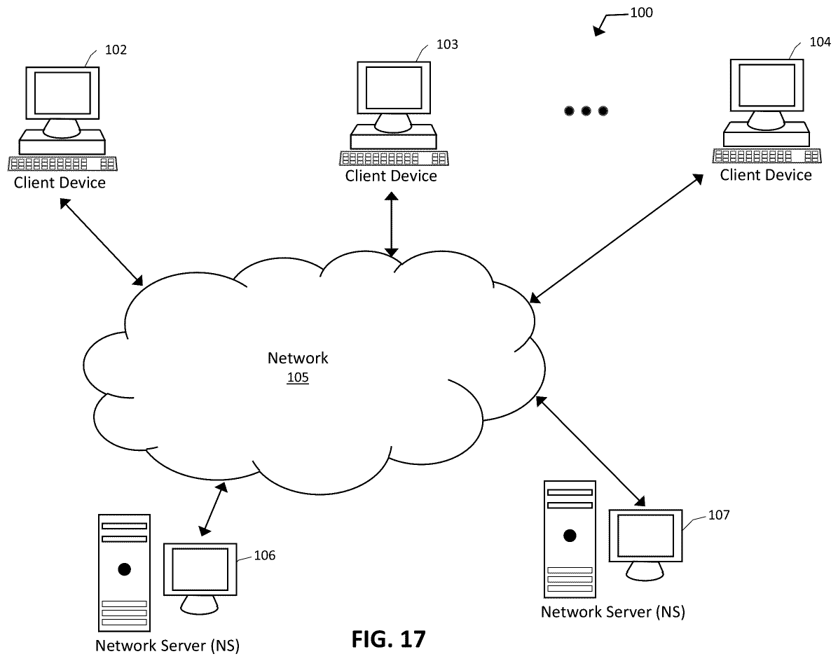

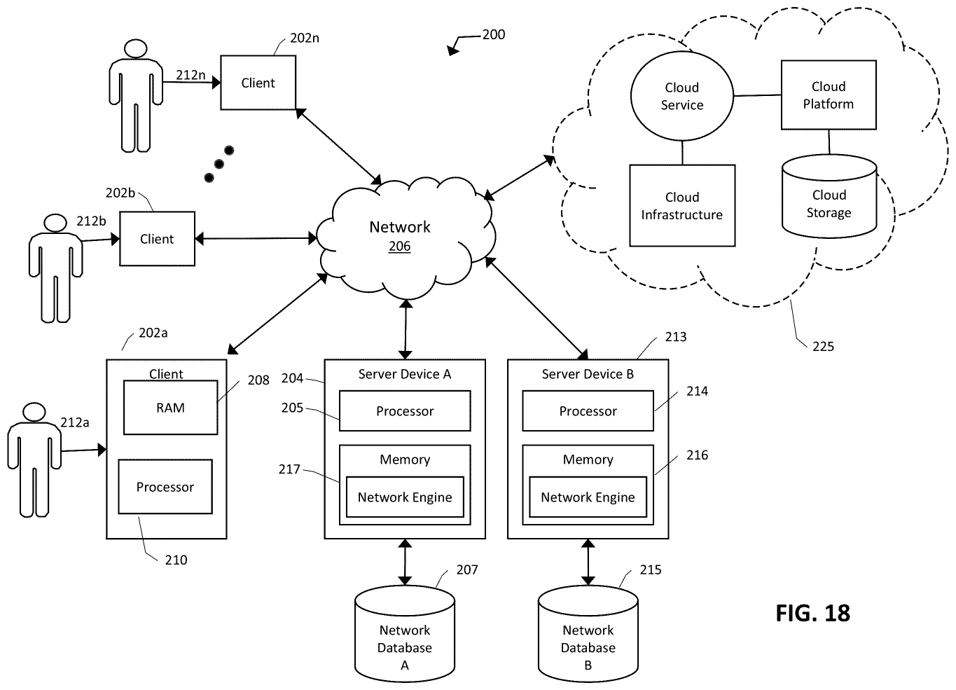

FIG. 1 is a block diagram illustrating a system 150 for performing cargo load planning for an aircraft in accordance with one or more embodiments of the present disclosure. In particular, the example of FIG. 1 includes a cargo load planning user device 155 connected to a network 180, such as the internet, an intranet, or any combination of networks and/or network devices that facilitate communication between computing devices (e.g., such as the networks 105 or 206 as described herein and shown in FIGS. 17 and 18, respectively). The cargo load planning user device 155 may be a device used by an airline employee, for example, to view the various graphical user interfaces described herein (e.g., as shown in and described with respect to FIGS. 3-7, 10-16). A user may also be able to make various inputs with the cargo load planning user device 155 as described herein to cause performance of the various cargo load planning embodiments described herein. The cargo load planning user device 155 may also communicate with the other devices in FIG. 1 as described herein to implement the methods, apparatuses, systems, computer readable media, and display graphical user interfaces as described herein. For example, the cargo load planning user device 155 may itself perform the processing to determine possible and/or recommended ULD configurations for a given flight as described herein. In other examples, another device such as a cargo load planning server device 160 may perform the processing to determine possible and/or recommended ULD configurations for a given flight, and such processing may be based on, for example, the inputs of the user that is using the cargo load planning user device 155 (e.g., a user may enter information, cause the cargo load planning server device 160 to perform the processing, etc. using the cargo load planning user device 155). In other examples, the processing may be split or otherwise done by multiple devices, such as through the combined efforts of the cargo load planning user device 155 and the cargo load planning server device 160.

The system 150 of FIG. 1 further includes a cargo management system server device 165, a cargo customer device 170, and a load worker computing device 175. The cargo management system server device 165 may be used to process and receive cargo orders, for example from the cargo customer device 170. The cargo customer device 170 may be used by a cargo customer to input information about a cargo order the cargo customer wishes to be shipped by an airline. The cargo customer device 170 and/or the cargo management system server device 165 may then communicate with the cargo load planning user device 155 and/or the cargo load planning server device 160 over the network 180 to provide information about the cargo shipment the cargo customer wishes to ship. That information may therefore be used by the cargo load planning user device 155 and/or the cargo load planning server device 160 to perform cargo load planning as described herein.

The load worker computer device 175 may be used by a load worker of the airline or associated with an airline. The load worker computer device 175 may receive instructions for how to load particular pieces of cargo into particular ULDs and how to load all ULDs for a flight into various compartments of a cargo hold of an aircraft for a given flight, as described herein based on the various cargo load planning embodiments. As such, the cargo load planning user device 155 and/or the cargo load planning server device 160 may perform the cargo load planning to output a recommended cargo load plan to the load worker computing device 175. A load worker may therefore view the cargo load plan on the load worker computing device 175 and load the cargo and ULDs into the aircraft according to the cargo load plan.

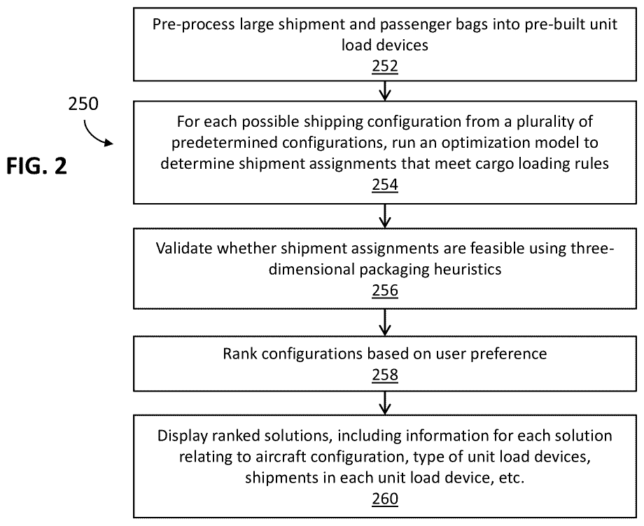

FIG. 2 is a diagram illustrating a process 250 for performing cargo load planning for an aircraft in accordance with one or more embodiments of the present disclosure. The process 250 demonstrates a divide-and-conquer approach as described herein that interactively solves for an optimal solution for load planning in a short time (e.g., after cargo orders have been received close to the time a flight departs but early enough to provide enough time to actually load the cargo after a load plan has been selected) while also maintaining proper aircraft weight balance at take-off and at landing. As an aircraft has many known configurations for ULDs and cargo, such a divide-and-conquer approach as described herein advantageously provides for selecting an aircraft configuration and finding the best shipment solution for that configuration. Such an approach provides a technical solution that breaks a large problem into many smaller problems that can be solved faster and more efficiently.

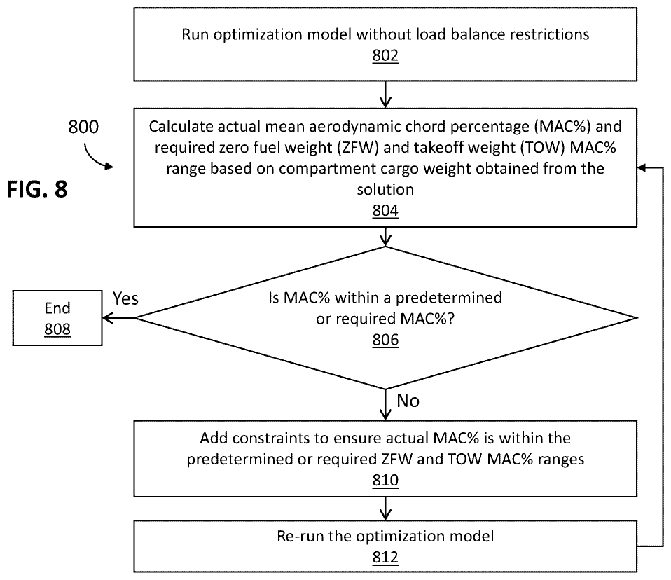

At an operation 252, large cargo shipments for a flight and passenger bags are pre-processed and sorted into or otherwise associated with pre-built unit load devices (ULDs) by the system. At an operation 254, for each possible shipping configuration from a plurality of predetermined configurations, an optimization model is run to determine shipment assignments (e.g., where ULDs can be stored in a plurality of predetermined slots or spaces with a cargo hold of an aircraft) that meet cargo loading rules. In other words, at the operation 254, from a total number of ULD configurations, the system determines whether each possible ULD configuration for the ULDs that were determined at the operation 252 meets various cargo loading rules such as weight balance rules for the aircraft. Thus, the system can determine based on the possible shipping configurations of a plurality of predetermined configurations for a given aircraft, which configurations meet certain rules. The operation 254 may include performing aircraft weigh balance calculations, including consideration of the center of gravity for zero fuel weight (ZFW) and the center of gravity for takeoff weight (TOW) when solving for best shipment allocation(s). Both centers of gravity, which are dependent on the shipment location on an aircraft, must follow a rule to maintain those two centers of gravity within a predetermined range. The center of gravity of an aircraft is dependent on both the total weight of the aircraft and any dynamic weight within the aircraft (including shipment weight and where those shipments/cargo are placed). Because shipment locations and weights are decision variables that affect center of gravity, considering centers of gravity if an aircraft may use a non-linear model, which may make optimizing for cargo loading difficult to solve. As such, the iterative, divide-and-conquer methods provided herein solve these problems more efficiently. How the center of gravity is calculated and considered at the operation 254 is further described herein, for example with respect to FIG. 8 and its associated description.

At an operation 256, shipment assignments for those possible shipping configurations that meet basic cargo loading rules are validated to determine whether such shipment assignments are feasible using three-dimensional bin packaging heuristics. For example, the system may check to ensure that each piece of cargo assigned to a ULD can actually fit in that ULD, since there is a limited amount of three-dimensional space in each ULD. Such a step is useful because weight balance calculations may not take into account the volume of a given piece of cargo. Thus, of the possible shipping configurations analyzed at the operation 254, some may be excluded because they include configurations that are impossible once the volume of each piece of cargo is considered.

At an operation 258, the configurations that are still possible after the operation 256 is performed may be ranked based on user preference. In some embodiments, the user preferences may be considered rules that are applied by the system, while in other embodiments the user preferences may be separate from rules applied by the system. For example, where user preferences are considered separate from rules, the rules may be related to mandatory conditions that must be met for a given cargo and ULD configuration to be considered possible while preferences may be optional. For example, a preference may be to first make sure that all cargo allocated to a flight goes into the aircraft for that flight and then if some cargo must be excluded that passenger bags and then higher value cargo are placed on the flight before lower value cargo. In such a scenario, multiple configurations for excluding different cargo may meet the mandatory rules such as weight balancing requirements, but the preferences may specify which configuration (e.g., which cargo to exclude) may be more preferable. A user may also specify such preferences through a user interface on a load planning user device (e.g., the cargo load planning user device 155 of FIG. 1). In the other embodiments, such user preferences may be treated and considered together by the system at the same time as mandatory rules (e.g., any combination of operations 254, 256, and 258 may be combined into one or two steps rather than three separate operations as shown in FIG. 2).

At an operation 260, the ranked configurations may be sent to and displayed on a computing device display (e.g., on the cargo load planning user device 155 and/or the load worker computing device 175 of FIG. 1). The display of such ranked configurations may include information for each solution, including information relating to the specific aircraft configuration in which cargo is being loaded, the type of ULDs to be used, what cargo to put in each ULD, where to place each ULD in the specific aircraft configuration of the aircraft for that flight, etc. In various embodiments, the output to the computing device display may display a predetermined number of ranked solutions, such as one solution (e.g., only the best solution is presented to the user on the display), two solutions, three solutions, four solutions, five solutions, six solutions, seven solutions, eight solutions, nine solutions, ten solutions, or more. The predetermined number of ranked solutions may be presented to the user on the display in order of a best recommended solution (e.g., a solution that is highest ranked based on the user preferences at the operation 258) to the least recommended solution of those being presented on the display. The predetermined number of ranked solutions that are presented on the display may also be adjusted by a user, such that different numbers of ranked solutions may be presented depending on the user's input. Where only one solution is displayed, there may be no rankings since the system is outputting what has been determined to be the best recommended solution for loading the cargo.

This divide-and-conquer approach and incorporating aircraft weight balance in the decision process of shipment allocation therefore advantageously provides for a practical, optimal, real-time solution in a short time that may incorporate late cargo orders from customers of an airline, while still providing the recommended solution(s) in time for load workers of an airline or associated with an airline to actually load the cargo into the aircraft before the departure time without delaying the flight. The embodiments described herein may also be used outside the airline industry to improve a more generalized process that involves in multi-stage, linear or nonlinear constraints in the last-stage decision making. For example, a decision space may be divided into a limited number of sub-spaces, and a divide-and-conquer approach to reduce the original problem size into multiple sub-problems may be used. Each subspace may then be solved for to easily obtain the best solution among all sub-spaces. The iterative method may also be applied to non-linear constraints that can be linearized by holding some variable at an estimated fixed value. Instead of solving a problem with non-linear constraints, which may be difficult or sometimes impossible to solve, solving the problems with the non-linear constraints or variables at an estimated fixed value (or iteratively with multiple different estimated fixed values) may be used to solve the problems iteratively using linear constraints as described herein.

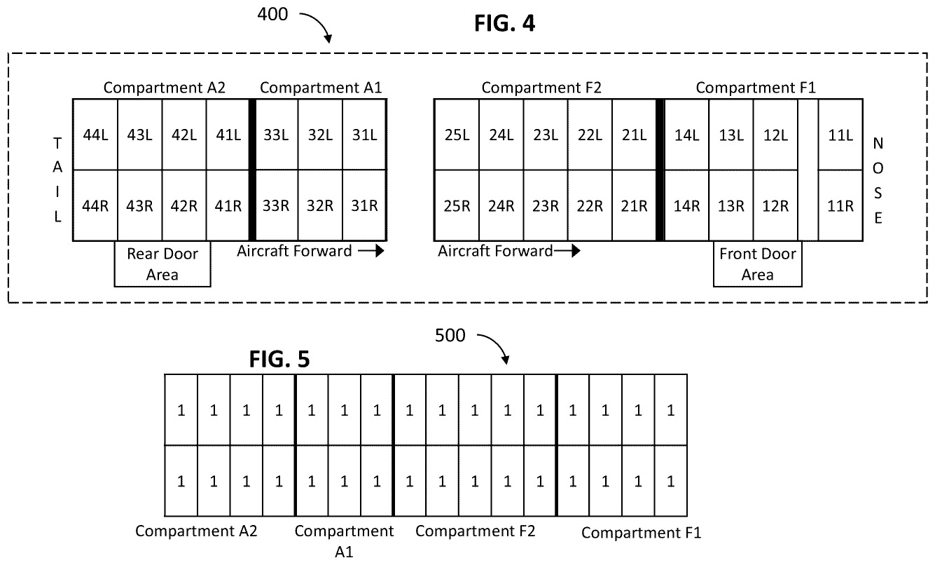

FIG. 3 is a block diagram illustrating an example cargo compartment configuration 300 of an aircraft in accordance with one or more embodiments of the present disclosure. FIG. 3 specifically that an example aircraft may have two main portions, an aft portion and a forward portion. While FIG. 3 along with FIGS. 4-7 shows an example of a particular aircraft configuration being used in accordance to the embodiments herein, such an example is merely illustrative, and the embodiments herein are adaptable and configurable to be used with any type of aircraft configuration. The configuration 300 in FIG. 3 specifically includes two compartments in the aft portion of the aircraft, aft compartment A1 302 and aft compartment A2 304. The configuration 300 in FIG. 3 specifically includes two compartments in the forward portion of the aircraft, forward compartment F1 306 and forward compartment F2 308.

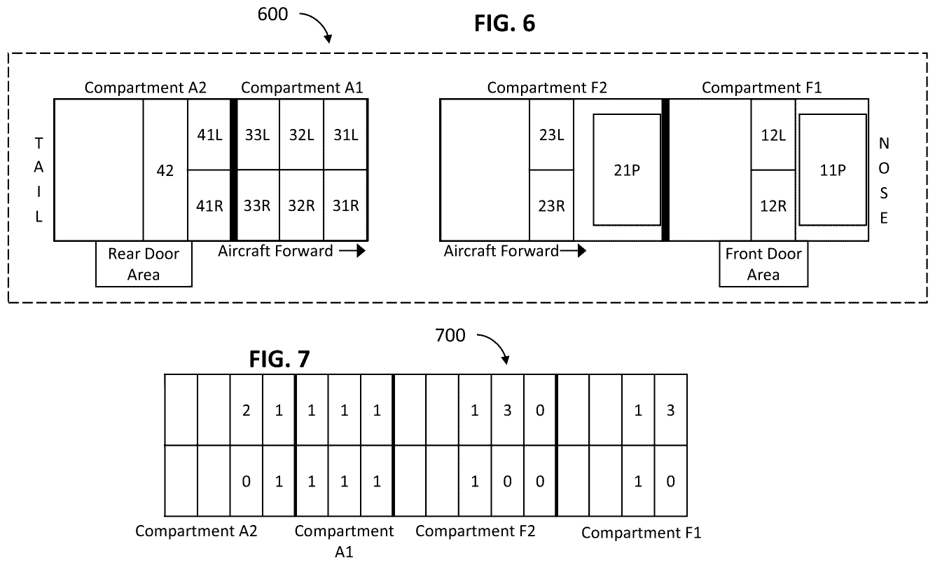

FIGS. 4 and 5 demonstrate a first shipping or ULD configuration for the example aircraft configuration of FIG. 3 and FIGS. 6 and 7 demonstrate a second shipping or ULD configuration for the example aircraft configuration of FIG. 3. In other words, each of FIGS. 4-7 relate to a same aircraft having the cargo compartments shown in FIG. 3 and associated with a particular type of aircraft from a particular manufacturer (e.g., a Boeing 777-200 in the example of FIG. 3), but FIGS. 4 and 5 show a first way in which ULDs may be loaded into that aircraft and FIGS. 6 and 7 show a second way in which ULDs may be loaded into that aircraft.

FIG. 4 is a block diagram illustrating a first example ULD configuration 400 for loading unit load devices (ULDs) in the example aircraft cargo compartment configuration 300 of FIG. 3 in accordance with one or more embodiments of the present disclosure. While FIG. 4 shows an example of how the aircraft with the configuration 300 may be loaded, other configurations may be used in various embodiments whether using this same aircraft or other types of aircraft. In this example, this aircraft configuration may accommodate or accept three different ULD types. A ULD type 1 may take a single position as shown in the ULD configuration 400 of FIG. 4 (e.g., may take up one of the positions 44L, 32L, 24R, 21L, 13L, 11R, etc.). A ULD type 2 may take up two consecutive vertical positions in the configuration shown in FIG. 4 (e.g., positions 42L and 42R together, positions 31L and 31R together, positions 14L and 14R together, etc.). A ULD type 3 may take up two to four positions depending on its placement within a given cargo compartment. For example, as will be discussed below with respect to FIGS. 6 and 7, a ULD type 3 may take up two positions when those positions are 11L and 11R since there is space between 12L and 11L (and 12R and 11R) such that a larger ULD may be positioned at 11L and 11R without taking up additional positions. However, if a ULD type 3 is placed at 14L, for example, the larger ULD type 3 may occupy 14L, 14R, 13L, and 13R (or at least will prevent other ULDs from being placed in those positions even if the ULD type 3 does not fully occupy all four of those positions). If two of the ULD type 3's are placed adjacent to one another, they may together take up 6 positions total. For example, 2 ULD type 3's may together take up positions 25L, 24L, 23L, 25R, 24R, and 23R in FIG. 4. This may be because the ULD type 3's only take up the equivalent of 3 positions in FIG. 4 each, so if placed next to one another the ULD type 3's may only take up 6 total positions in various embodiments.

FIG. 5 is a diagram illustrating a first example data table 500 representing the first example ULD configuration 400 for loading the unit load devices (ULDs) of FIG. 4 in accordance with one or more embodiments of the present disclosure. In the example of FIG. 5, the data table 500 has all ones, indicating that type ULDs may be loaded into every single position shown in the ULD configuration 400 of FIG. 4. This is just one ULD configuration that is possible between the various different types of ULDs (in this case three different ULD types). The data table 500 may be output, for example, to the cargo load planning user device 155 and/or the load worker computing device 175 so that the ULD configuration 400 represented by the data table 500 may be viewed and implemented by a load worker, for example. In other words, the data table 500 or similar may be used to instruct, in part, a load worker on how to load cargo into an aircraft with the configuration shown in FIGS. 3-5.

FIG. 6 is a block diagram illustrating a second example ULD configuration 600 for loading unit load devices (ULDs) in the example aircraft cargo compartment configuration of FIG. 3 in accordance with one or more embodiments of the present disclosure. The ULD configuration 600 includes using ULDs of all three types described above. For example, at positions 42L and 42R may be a single ULD of type 2 as denoted by the number 42. At positions 22L, 22R, 21L, and 21R is a ULD type 3 denoted by 21P. At positions 11L and 11R is a ULD type 3 denoted by 11P. Positions 41L, 41R, 33L, 33R, 32L, 32R, 31L, 31R, 23L, 23R, 12L, and 12R are filled by ULD type 1's. Other positions may be left blank or empty with no ULDs loaded there as shown in FIG. 6, such as the ULD positions depicted in FIG. 4 of 44L, 44R, 43L, 43R, 25L, 25R, 24L, 24R, 14L, 14R, 13L, and 13R.

FIG. 7 is a diagram illustrating a second example data table 700 representing the example ULD configuration 600 for loading the unit load devices (ULDs) of FIG. 6 in accordance with one or more embodiments of the present disclosure. The data table 700 represents the ULD configuration 600 depicted in FIG. 6. That is, l's may represent positions where ULD type 1's should be loaded, 2's may represent where ULD type 2's should be loaded, and 3's represent positions where ULD type 3's should be loaded. Zeroes may be used where there is a ULD loaded but associated with a nearby or adjacent ULD. For example, the zero in position 42R is shown because the ULD represented by the two in position 42L may take up the space of both 42R and 42L. However, the two and zero may be used in the data table 700 to make it easily apparent that there is only one ULD type 2 located at the positions 42R and 42L. In other words, the zeroes may be used where an adjacent or nearby ULD is larger than one position (e.g., ULD types 2 or 3), and are loaded such that they take up part or all of an adjacent position and no other ULD can be placed there. In other words, those positions may appear as zeroes in the data table 700 but it will be understood by a load planner that those positions will be taken up by another ULD in an adjacent position. In this way, the data table 700 may be output on a display of a computing device such as the cargo load planning user device 155 and/or the load worker computing device 175 so that the ULD configuration 600 represented by the data table 700 may be viewed and implemented by a load worker, for example. As another example, the three in the data table at position 22L has three zeroes around it at positions 22R, 21R, and 21L because the ULD 21P is of a size that no other ULDs may be loaded into any of positions 22R, 21R, and 21L. Similarly, the three in the data table at position 11L has a zero next to it at position 11R because the ULD 11P is of a size that no other ULD may be loaded into position 11R. The blanks in the data table 700 where no numeral is shown represent positions in the compartment where there may be no ULDs loaded at all according to a given ULD configuration (in this case the ULD configuration 600, which has no ULDs at positions 44L, 44R, 43L, 43R, 25L, 25R, 24L, 24R, 14L, 14R, 13L, and 13R).

As described herein, various embodiments include a process to perform weight balance calculations and consider other constraints, rules, preferences, etc. to determine possible and recommended configurations for ULDs in a given aircraft for a given flight. For example, the process of FIG. 2 may include the calculations and processes below when the process 200 is implemented by one or more computing devices as described herein. For example, considering the following:

### Indices:

i—is a position i on the aircraft
k—is a particular shipment k
j—the type of ULD (e.g., 1, 2, or 3 as described herein)

### Set of Indexes:

C—the set of compartments
S—the set of shipments
U—the set of ULD types
P—the set of shipment priority levels

### Parameters:

$${D}_{k}^{1} - largest dimension of shipment k$$

$${D}_{k}^{2} - {2}^{nd} largest dimension of shipment k$$

$${D}_{j}^{1} - largest dimension of ULD type j$$

$${D}_{j}^{2} - {2}^{nd} largest dimension of ULD type j$$

vₖ—volume of shipment k
wₖ—weight of shipment k

$${C}_{j}^{w} - Maximum weight allowed by ULD type j$$

$${C}_{j}^{v} - Maximum volum of ULD type j$$

Sⱼ—maximum number of ULD type j available
W_{A1}—maximum weight allowed by compartment A1
W_{A2}—maximum weight allowed by compartment A2
W_{F1}—maximum weight allowed by compartment F1
W_{F2}—maximum weight allowed by compartment F2
γ^{w}—Weight utilization of ULD
γ^{v}—Volume utilization of ULD
penaltyₖ—Penalty factor for shipment k (based on its priority)
αₖ—position factor,
   αₖ=1 means ULD type 1 or 2,
   αₖ=2 means ULD type 3

### Variable Definitions:

x_{i,j}—Position i has ULD type j if x_{i,j}=1
z_{k,i,j}—Shipment k is assigned to position i that has ULD type j if z_{k,i,j}=1
yₖ—Shipment i is offloaded if yₖ=1
x_{i,j}, yₖ, and z_{k,i,j} are binary variables.

Accordingly, Equation 1 below may be used to achieve an objective of minimizing offload weight weighted by priority factor and the number of ULDs used:

$$Minimize {\sum }_{k ∈ K} {penalty}_{k} {w}_{k} {y}_{k}^{w} + {\sum }_{i , j} {x}_{ij} \qquad ( Eq . 1 )$$

In various embodiments, the calculations may further be subject to various rules, such as the following example rules (which may be used all together or fewer than the total rules below may be used in any combination):
1. A shipment can be assigned to one ULD or offloaded (e.g., not included as a shipment for a given flight and held for a subsequent flight).
2. A shipment cannot be assigned to a ULD if its maximum dimensions exceed the maximum dimensions of the ULD.
3. Total shipments that are assigned to a ULD cannot exceed the ULD's max weight or max volume.
4. The number of ULDs used must be within the maximum number of ULDs available.
5. The total weight by compartment must be within the maximum weight allowed for that compartment.
6. The ULDs used must meet the configuration restrictions (e.g., must all fit into an appropriate place in a cargo hold in which the ULD can be properly secured).
7. Pre-build containers must be put in the positions allowed for the prebuild ULD type.
   a. Pre-build containers cannot be mixed with other shipments.
8. Passenger bags must be put in ULD type 1 (cannot be put in ULD type 2 or 3) and must be put in an Aft compartment (e.g., one of compartments 302 and 304 of FIG. 3) and be put in a Forward compartment (e.g., one of compartments 306 and 308 of FIG. 3) only if the number of bags exceeds the maximum number of ULDs allowed in the Aft compartments.
   a. Bags cannot be in F2 (or compartment 308 of FIG. 3) (as there are no doors in F2 to quickly access bags after landing)
9. Shipments must meet the aircraft weight balance requirement once placed in ULDs and loaded into aircraft.

A shipment may therefore be assigned to one position or offloaded according to Equation 2 below:

$${y}_{k} + {\sum }_{i ∈ I} {\sum }_{j ∈ J} {z}_{k , i , j} = 1 ∀ k ∈ K \qquad ( Eq . 2 )$$

A shipment may not be assigned to position i if its max dimension exceeds the ULD's max dimension in accordance with Equations 3a to 3c below:

$${z}_{k , i , 1} = 0 if {α}_{i} = 1 and ( {D}_{k}^{1} > {D}_{ULD 1}^{1} or {D}_{k}^{2} > {D}_{ULD 1}^{2} ) \qquad ( Eq . 3 a )$$

$${z}_{k , i , 2} = 0 if {α}_{i} = 1 and ( {D}_{k}^{1} > {D}_{ULD 2}^{1} or {D}_{k}^{2} > {D}_{ULD 2}^{2} ) \qquad ( Eq . 3 b )$$

$${z}_{k , i , 3} = 0 if {α}_{i} = 2 and ( {D}_{k}^{1} > {D}_{ULD 3}^{1} or {D}_{k}^{2} > {D}_{ULD 3}^{2} ) \qquad ( Eq . 3 c )$$

The total shipments assigned to position i must be within weight and volume limit of position i in accordance with Equations 4a and 4b below:

$${\sum }_{k} {v}_{k} {z}_{k , i , j} \leq {γ}^{v} {C}_{j}^{v} {x}_{i , j} , ∀ i ∈ I , j ∈ J \qquad ( Eq . 4 a )$$

$${\sum }_{k} {w}_{k} {z}_{k , i , j} \leq {γ}^{w} {C}_{j}^{w} {x}_{i , j} , ∀ i ∈ I , j ∈ J \qquad ( Eq . 4 b )$$

The number of ULDs used must be within the maximum number of ULDs available in accordance with Equation 5 below:

$${\sum }_{i} {x}_{i , j} \leq {S}_{j} ∀ j ∈ J \qquad ( Eq . 5 )$$

The total weight by compartment must be within the maximum weight allowed for that compartment in accordance with Equations 6a to 6d:

$${\sum }_{i ∈ A 1} {\sum }_{k} {w}_{k} {z}_{k , i , j} \leq {W}_{A 1} \qquad ( Eq . 6 a )$$

$${\sum }_{i ∈ A 2} {\sum }_{k} {w}_{k} {z}_{k , i , j} \leq {W}_{A 2} \qquad ( Eq . 6 b )$$

$${\sum }_{i ∈ F 1} {\sum }_{k} {w}_{k} {z}_{k , i , j} \leq {W}_{F 1} \qquad ( Eq . 6 c )$$

$${\sum }_{i ∈ F 2} {\sum }_{k} {w}_{k} {z}_{k , {i}_{,} j} \leq {W}_{F 2} \qquad ( Eq . 6 d )$$

The ULDs used must also meet the configuration restrictions. That is, shipment k must be put in the positions allowed for each ULD type as shown below:

```
if αᵢ = 0, then Z_{k,i,j} = 0 for j=1, 2, 3
if αi = 1, then
  Z_{k,i,j} = 0 if j=2 and i%2≠0
  Z_{k,i,j} = 0 if j=3
if αᵢ = 2, then
  Z_{k,i,j} = 0 if j=1,2
```

Pre-build containers must be put in the positions allowed for the prebuild ULD type (although three different types of ULDs are discussed herein, alternative and/or additional ULD types may be used in various embodiments):

```
If prebuidIdx=1
  z_{k,i,j} = 0 for all i and j=2, 3
  For j=1
    if αᵢ = 0 then z_{k,i,j} = 0
    if αᵢ = 1 then
        z_{k,i,j} ≤ x_{i,j} it can be any location if there is a type 1 ULD in
          that position
        if αᵢ = 2 then x_{k,i,j} = 0
If prebuidIdx=2
  z_{k,i,j} = 0 for all i and j=1, 3
  for j = 2
    if αᵢ = 0 then z_{k,i,j} = 0
    if αᵢ = 1 then
        z_{k,i,j} ≤ x_{i,j} for all i%2=0 (top position), it can be any
          location if there is a type 2 ULD in that position
        z_{k,i,j} = 0 for all i%2≠0 ( bottom position)
    if αᵢ = 2 then x_{k,i,j} = 0
If prebuidIdx=3
  z_{k,i,j} = 0 for all i and j=1,2
  For j = 3
    if αᵢ = 0 then z_{k,i,j} = 0
    if αᵢ = 1 then z_{k,i,j} = 0
    if αᵢ = 2 then z_{k,i,j} ≤ x_{i,j} it can be any position if there is a type 3
      ULD in that position
```

Passenger bags must be put in Aft first and Forward if Aft does have enough space, as shown below:
If # of bags ≤8, they should be put in A2 (cannot be put in F1, F2, or A1)
If # of bags ≤14, 8 of then should be put in A2, remaining in A1 (cannot be put in F1 or F2)
If # of bags >14, 8 of then should be put in A2, 6 in A1, remaining in F1 (cannot be put in F2)

Shipments must meet the aircraft weight balance requirement, as shown below in Equations 7a to 7c:

$$LEMAC + MAC \times {R}_{Z F W}^{LB} < \frac{{L}_{1} + ( {z}_{F 1} {A}_{F 1} , {z}_{F 2} {A}_{F 2} , {z}_{A 1} {A}_{A 1} , {z}_{A 2} {A}_{A 2} )}{Z + {W}_{1} - {W}_{EOWX}} < LEMAC + MAC \times {R}_{ZFW}^{UB} \qquad ( Eq . 7 a )$$

$$LEMAC + MAC \times {R}_{TOW}^{LB} < \frac{{L}_{2} + ( {z}_{F 1} {A}_{F 1} , {z}_{F 2} {A}_{F 2} , {z}_{A 1} {A}_{A 1} , {z}_{A 2} {A}_{A 2} )}{Z + {W}_{2} - {W}_{EOWX}} < LEMAC + MAC \times {R}_{TOW}^{UB} \qquad ( Eq . 7 b )$$

$${W}_{1} + z - {W}_{EOWX} \leq {W}_{max} \qquad ( Eq . 7 c )$$

Where LEMAC and MAC are constants and specific to the aircraft type. Further:

$${R}_{ZFW}^{LB} - the lower bound of center of gravity at landing ( Zero Fuel Weight ( ZFW ) ) .$$

$${R}_{ZFW}^{UB} - the upper bound of center of gravity at landing ( Zero Fuel Weight ( ZFW ) ) .$$

$${R}_{TOW}^{LB} - the lower bound of center of gravity at takeoff ( Take Off Weight ( TOW ) ) .$$

$${R}_{TOW}^{UB} - the upper bound of center of gravity at takeoff ( Take Off Weight ( TOW ) ) .$$

### And:

$${R}_{ZFW}^{LB} , {R}_{ZFW}^{UB} , {R}_{TOW}^{LB} , {R}_{TOW}^{UB}$$

vary depending on the value of ZFW and TOW.
L1 is the moment of aircraft weight and passenger weight.
z_{F1}, z_{F2}, z_{A1}, z_{A2} are the sum of shipments weight in compartment F1, F2, A1, and A2 and are decision variables.
Z=z_{F1}+z_{F2}+z_{A1}+z_{A2}. Z is a decision variable.
A_{F1}, A_{F2}, A_{A1}, A_{A2} are arms of compartment F1, F2, A1, and A2. They are constants.
W₁ is the sum of the aircraft weight and passenger weight.
W₂ is the sum of W₁ and release fuel weight.
And W_{EOWX} is the empty operating weight exception. Aircraft weight is calculated based on some standard assumption. W_{EOWX} is the weight that is included in the standard assumption but not actually present. For example, the standard calculation may assume 18 ULD type 1, 0 ULD type 2, and 0 ULD type 3 in Forward compartment, and 14 ULD type 1, 0 ULD type 2, and 0 ULD type 3 in Aft compartment. If the actual number of ULDs for a given ULD type by compartment is not the same the assumed, then w_{EOWX} is not zero.

Note that constraints described in Equations 7a and 7b are non-linear because w_{EOWX} is dependent on the value of z_{k,i,j}. This may make the problem difficult to solve. As such, an iterative process may be used to solve the problem. FIG. 8 illustrates such a solving process. FIG. 8 is a diagram illustrating a process 800 running an optimization model for performing cargo load planning for an aircraft in accordance with one or more embodiments of the present disclosure.

At an operation 802, the optimization model may be run without load balance restrictions. In other words, a process such as the process 250 shown in FIG. 2 may be run without regard for load balance restrictions. At an operation 804, an actual mean aerodynamic chord percentage (MAC %) and required ZFW and TOW MAC % range based on compartment cargo weight obtained from the solution (e.g., based on one or more ranked solutions from the process 250 shown in FIG. 2).

At an operation 806, the system determines whether the MAC % is within a predetermined or required MAC %. If the MAC % is within the predetermined or required MAC %, the process 800 ends at 808. If the MAC % is not within the predetermined or required MAC %, the process proceeds to operation 810.

At the operation 810, constraints are added to ensure actual MAC % is within the predetermined or required ZFW and TOW MAC % ranges. Then, at an operation 812, the optimization model (e.g., the process of FIG. 2) is re-run with the added constraints and the operations 804, 806 (and potentially 810 and 812) are re-run until the MAC % is within a predetermined or required MAC %. As such, this iterative process may be executed to achieve an improved way to perform cargo load planning and center of gravity/weight balancing calculations such that cargo load planning incorporates weight balancing concerns and constraints.

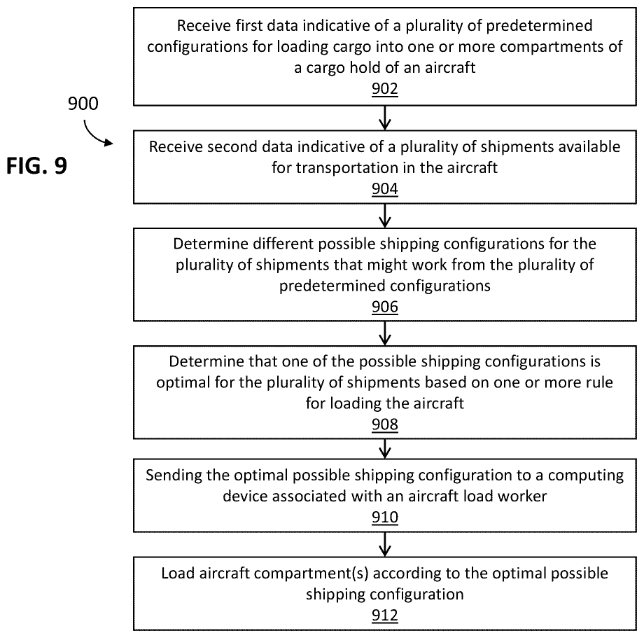

FIG. 9 is a diagram illustrating a process 900 for performing cargo load planning for an aircraft and subsequently loading the aircraft with cargo in accordance with one or more embodiments of the present disclosure. While the process 900 describes cargo load planning broadly, various stages of the process 900 may include some or all of the various processes (e.g., the process 200 of FIG. 2 and/or the process 800 of FIG. 8), methods, and calculations described herein for load planning. For example, embodiments herein may include methods, systems, and computer readable media that, at an operation 902, receive or otherwise have stored on a memory a plurality of predetermined configurations for loading cargo into a compartment of a cargo hold of an aircraft. These predetermined configurations may represent the different possible ULD positions within a particular aircraft and what types of ULDs may be loaded into each different ULD position. In other words, this information may include various possible layouts of a plurality of unit load devices for a given aircraft cargo compartment (or compartments where an aircraft has more than one cargo compartment). There may be more than one type of ULD, so the data may further indicate what type of ULDs may be placed at different positions: some positions may accommodate only a single type of ULD, some positions may accommodate multiple types of ULDs, and some ULDs may occupy one or more positions as discussed further herein.

At an operation 904, data may be received relating a plurality of shipments available for transportation in the aircraft for a particular flight. In other words, a computing device may receive information about different pieces of cargo for which it is desired to ship or transport on a given flight in a given aircraft. The plurality of shipments may be (1) pre-packaged into a first unit load device type of the at least two different types of unit load devices (e.g., shipments or passenger baggage placed into a ULD) or (2) configured for placement into a second unit load device type of the at least two different types of unit load devices (e.g., pre-packaged ULDs). The receiving of the second data indicative of the plurality of shipments available for transportation in the aircraft occurs a predetermined amount of time before a scheduled flight (e.g., anywhere from 15 minutes to 48 hours, such as approximately 15 minutes, approximately 30 minutes, approximately 45 minutes, approximately one hour, approximately two hours, approximately three hours, approximately four hours, approximately six hours, approximately eight hours, approximately ten hours, approximately twelve hours, approximately sixteen hours, approximately twenty hours, approximately twenty-four hours, approximately thirty hours, approximately thirty-six hours, approximately forty-two hours, or approximately forty-eight hours before the scheduled flight).

The system may further receive information that may be use as constraints, rules, user preferences, etc. for performing cargo load planning. For example, the system may further receive an input from a user via a user interface or from another computing device that indicates whether one or each of the plurality of shipments is stackable. As another example, the system may further receive an input from a user via a user interface or from another computing device that indicates whether one of the plurality of shipments is a priority shipment (e.g., if a customer paid more to guarantee delivery by a predetermined time and/or date).

At an operation 906, the system may determine a plurality of possible shipping configurations from the plurality of predetermined configurations, each one of the plurality of possible shipping configurations including an assignment of each of the plurality of shipments into or as one of the plurality of unit load devices and an assigned location of each of the plurality of unit load devices within the cargo hold of the aircraft according to the possible layout of each of the plurality of possible shipping configurations. In other words, the system may determine how the various cargo shipments may fit into ULDs that may be loaded into the aircraft in any of the plurality of predetermined configurations. In doing so, the system may determine which of the plurality of predetermined configurations are possible and where the cargo would go in each of those possible predetermined configurations. As described herein, this may be done prior to checking weight balancing and/or other rules for the flight.

At an operation 908, the system determines, based on at least one rule related to weight balancing of the aircraft, one of the plurality of possible shipping configurations that satisfies the at least one rule. In various embodiments, there will be more than one rule related to weight balancing. As described herein, the system may also apply other rules, constraints, or preferences that are not related to weight balancing.

The rules applied at the operation 908 may include various rules, constraints, and/or preferences as described herein, such as a first requirement that a first center of gravity for a takeoff weight of the aircraft is within a first predetermined range and a second requirement that a second center of gravity for a zero fuel weight of the aircraft is within a second predetermined range. Other rules, constraints, and/or preferences that may be applied at the operation 908 may include any combination of the following: a requirement that a total weight of the plurality of shipments in the plurality of unit load devices of the one of the plurality of possible shipping configurations is at or less than a total permitted weight of the compartment; a requirement that a first unit load device of the plurality of unit load devices having a high priority level is included in the one of the plurality of possible shipping configurations and that a second unit load device of the plurality of unit load devices having a low priority is optionally included in the one of the plurality of possible shipping configurations; a requirement that a weight balance of the aircraft is within a predetermined range based on each of the one of the plurality of possible shipping configurations, an estimated weight of passengers on a flight, and an estimated weight of passenger checked bags for the flight; a requirement, for the recommended assignment of each of the plurality of shipments into one of the plurality of unit load devices, that each of the plurality of shipments that are configured for placement into the second load device type fit into a respective unit load device of the plurality of unit load devices that are of the second load device type; and/or a requirement that the plurality of unit load devices fit in the compartment of the cargo hold.

Where an aircraft has more than one compartment, such as a first compartment and a second compartment, a rule may be applied to ensure that both a first total weight of a first subset of the plurality of shipments in the plurality of unit load devices of the one of the plurality of possible shipping configurations for the first compartment is at or less than a first total permitted weight of the first compartment and that a second total weight of a second subset of the plurality of shipments of the plurality of unit load devices of the one of the plurality of possible shipping configurations for the second compartment is at or less than a second total permitted weight of the second compartment.

Applying the rules, constraints, and/or preferences at the operation 908 may further include determining that at least one of the plurality of shipments will not be loaded onto a given scheduled flight of the aircraft (e.g., cargo or shipment will be offloaded). In such a case, the system may send, by the processor to a computing device associated with an aircraft load worker, the one of the plurality of possible shipping configurations that satisfies the at least one rule (or multiple ranked solutions as described herein) where the offloaded cargo/shipment(s) are not included in the data table or other information provided to a load worker. The optimal or ranked shipping configurations may be sent to the load worker or other computing device before any of the plurality of shipments are loaded onto the aircraft in advance of the given scheduled flight, since the load worker will typically use the information sent to load the ULDs and load the ULDs into the aircraft. For example, sending of the optimal or ranked shipping configurations for cargo for a flight may be send to the load worker computing device a predetermined amount of time before a scheduled flight (e.g., anywhere from 15 minutes to 48 hours, such as approximately 15 minutes, approximately 30 minutes, approximately 45 minutes, approximately one hour, approximately two hours, approximately three hours, approximately four hours, approximately six hours, approximately eight hours, approximately ten hours, approximately twelve hours, approximately sixteen hours, approximately twenty hours, approximately twenty-four hours, approximately thirty hours, approximately thirty-six hours, approximately forty-two hours, or approximately forty-eight hours before the scheduled flight).

At an operation 910, the system sends the optimal possible shipping configuration (or a predetermined number of top ranked shipping configurations that all meet weight balancing rules), to a computing device associated with an aircraft load worker (e.g., the cargo load planning user device 155 and/or the load worker computing device 175 of FIG. 1). In this way, the optimal or top ranked shipping configuration(s) may be displayed so the load worker may place shipments in the desired ULDs and load the ULDs into the desired locations within a cargo hold of an aircraft for a given flight as part of an operation 912. As described herein, the display may include information adequate to load the plurality of shipments into the cargo hold of the aircraft according to the optimal possible shipping configuration (or according to each of the predetermined number of top ranked shipping configurations). When the predetermined number of top ranked shipping configurations are sent to a device, the user may select one of the ranked shipping configurations at a time to cause the display to display more details about the configuration, including specifics on how to load cargo according to such a selected configuration. In any event, the output to the display may be, for example, a data table such as the data tables 500 or 700 depicted in FIGS. 5 and 7, respectively. Any other output may also be used in order to instruct a load worker on how to load cargo based on the embodiments for cargo load planning described herein. In other words, the instructions for loading cargo may include any combination of the following: an instruction to load particular shipments of the plurality of shipments into a particular unit load device that will be loaded into the cargo hold and/or a position indicator for a position in the cargo hold where each of the unit load devices that will be loaded into the cargo hold will be placed.

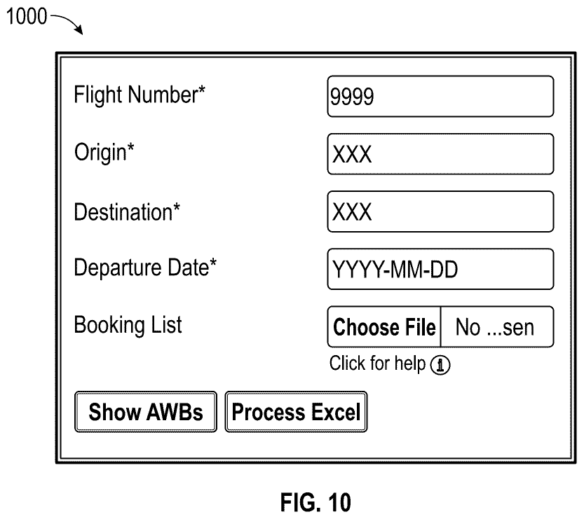

FIG. 10 is a block diagram illustrating a computerized user interface 1000 for entering flight information in accordance with one or more embodiments of the present disclosure. The interface 1000 may be a first interface when using a software program having instructions stored on a memory executed by a processor. The interface 1000 includes fields for a user to enter information to locate and/or specify a particular flight. For example, a user may enter one or more of a flight number, an origin airport, a destination airport, and/or a departure date. The user may also use the Choose File button to attach a booking list for the flight. Such a booking list may be, for example, an excel file or other data file that includes passenger information, fuel information, and/or cargo/shipments associated with a given flight (e.g., cargo/shipments that are associated with the flight as being desired to ship on a given flight prior to performing any cargo load planning for that flight—that is, some of the cargo/shipments associated with a flight could be offloaded from the flight in various embodiments).

This information may also be displayed on a display in various ways, as discussed further herein. In various embodiments, rather than uploading a document with information for the flight as shown in FIG. 10, the information for the flight or the booking list may be automatically imported or received from another software program running on the same or a different computing device than that displaying the interface 1000. For example, certain cargo/shipment information associated with a given flight specified in the data fields of the interface 1000 may be imported from or received from a cargo management system device (e.g., the cargo management system server device 165 of FIG. 1). An air cargo management system may be, for example, iCargo or any other third-party software or service for managing cargo. In various embodiments, an in-house cargo management system associated with the airline itself (e.g., not a third-party controlled software) may be used instead of or in addition to a third-party software or service. Other passenger and fuel information included in the booking list may be received from a computing device associated with an airline that sells tickets to passengers, allows users to book flights with the airline, etc. In another embodiments, all the information in the booking list may be received from a computing device associated with the airline, because the airline computing device may have previously received cargo/shipment information associated with the flight from a cargo management system device. In another embodiments, the cargo management system and the airline may be the same thing, so devices may be associated with a cargo management airline for example.

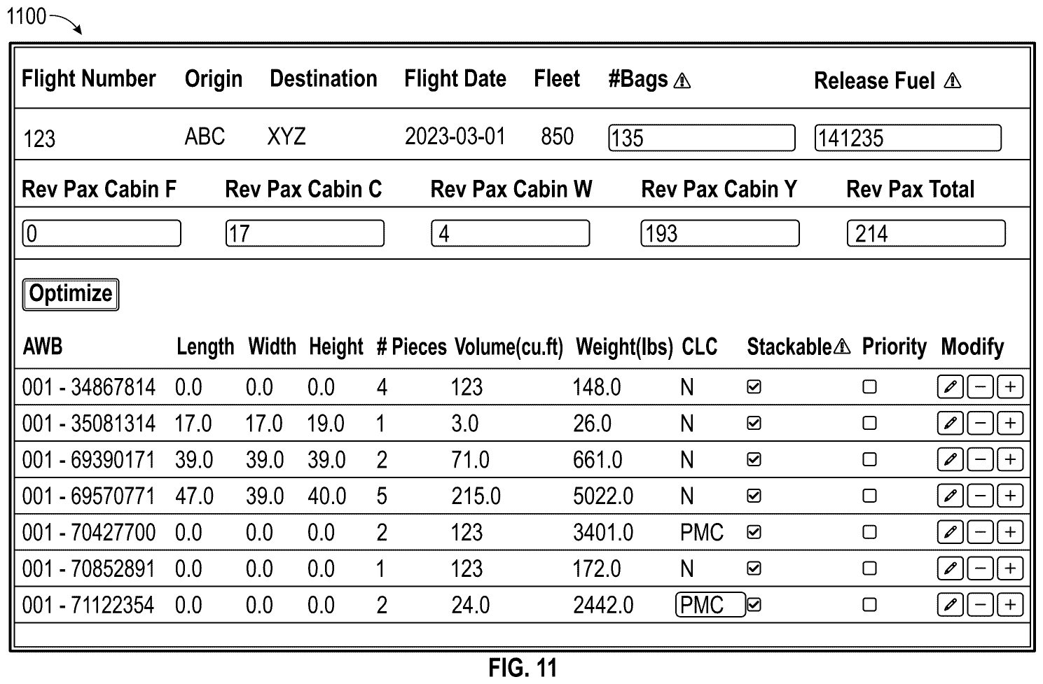

The Show AWBs button in the interface 1000 may cause the computing device to show all air waybills (AWBs) associated with the flight from the booking list received by or uploaded by the computing device. In this way, a user can quickly see the AWBs associated with the flight specified in the fields of the interface 1000 prior to doing any cargo load planning. The interface 1000 further includes a Process Excel button that, upon selection by a user, processes the information included in the booking list to begin cargo load planning. Upon selecting the Process Excel button, the computing device may proceed to displaying an interface as depicted in FIG. 11.

FIG. 11 is a block diagram illustrating a computerized user interface 1100 for performing and optimizing cargo load planning for an aircraft in accordance with one or more embodiments of the present disclosure. The interface 1100 shows information as-processed from the booking list, including passenger information, fuel information, and shipment/cargo information associated with the flight specified in the interface 1000 of FIG. 10. For example, information about the flight as entered into the interface 1000 is shown (e.g., flight number, origin, destination, date, airline flight/fleet number). The interface 1100 also shows a number of estimated bags for the flight, an estimated amount of fuel that will be released during the flight, and the number of passengers that are estimated to be in each cabin (and a total number of all estimated passengers) for the flight.

In various embodiments, the number of estimated bags for the flight, an estimated amount of fuel that will be released during the flight, the number of passengers that are estimated to be in each cabin, and/or the total passengers estimated for the flight may be manually adjusted by the user. In various embodiments, the user may not be able to manually adjust these values. In various embodiments, the user may be able to manually adjust these values, but only within a certain predetermined range or according to certain rules to prevent the user from deviating too far from the estimated values. For example, a user may only be able to increase a value and not decrease it to ensure that the manual changes by the user only add weight to the aircraft. In various embodiments, a user may make manual changes to one or more of these values if the user knows the information for the flight is going to be changed but has not yet been updated in the system, such as additional passengers being on the plane (adjust passenger count and/or bag estimate up); passengers will not be making the flight (adjust passenger count and/or bag estimate down); that the flight will be releasing more or less fuel than originally planned, such as when a flight plan changes such as to go around a storm or if a storm clears up (adjust release fuel up or down); and/or when the plane is planning to carry more or less weight in fuel than originally estimated.

The interface 1100 further displays information relating to air waybills (AWBs) that include cargo/shipments associated with the flight, including an AWB number, dimension information for each shipment (length, width, height), how many pieces are associated with each AWB, the total volume of shipments associated with each AWB, the total weight of shipments associated with each AWB, a centralized load control (CLC) designation for each AWB, a stackable designation for each AWB, and a priority designation for each AWB. The CLC designation may appear as N for no, indicating that a shipment is not a pre-packaged pallet or ULD and that the shipment may be placed or loaded into an ULD. If the CLC designation is marked as PMC, the ULD may be a pre-packaged pallet such that the shipment itself is considered a ULD for cargo load planning rather than a shipment that needs to be placed into a ULD for cargo load planning. The CLC designation may be manually updated by the user. In various embodiments, the CLC designation may further allow for different ULD types to be designated manually for certain types of shipments (e.g., ULD types 1, 2, or 3 as described herein may be manually designated).

The stackable designation may indicate whether the shipment can be stacked with, on, or be stacked on other shipments. The stackable designation may be manually updated by the user to toggle the stackable designation on and off. If shipment is marked unstackable, the system may consider the height of that shipment to be the maximum height possible for fitting into a ULD so that the system does not consider that anything could go on top of or underneath that shipment.

The priority designation may also be manually updated by the user to toggle on and off and indicates whether the shipment is a high priority or not. As described herein, the priority designation may be used in load planning to prioritize certain shipments if not all shipments associated with a flight will actually be able to fit in the cargo hold of the aircraft for the given flight. While the interface 1100 shows a binary option for a priority level (on/off), other embodiments may have a predetermined number of priority levels greater than two (e.g., three priority levels, four priority levels, five priority levels, six priority levels), such that each shipment may be assigned a priority level that provides more granularity to priority than just a high or low priority provided by a binary option.

A modify column of the interface 1100 permits a user to edit data associated with a particular AWB, remove the particular AWB from being associated with the flight (e.g., exclude the AWB from cargo load planning for the flight), and add a new AWB to be associated with the flight (e.g., include a new AWB in cargo load planning for the flight).

Lastly, the interface 1100 includes an Optimize button. The user may select the Optimize button to cause the system to perform the cargo load planning for the flight according to the embodiments described herein.

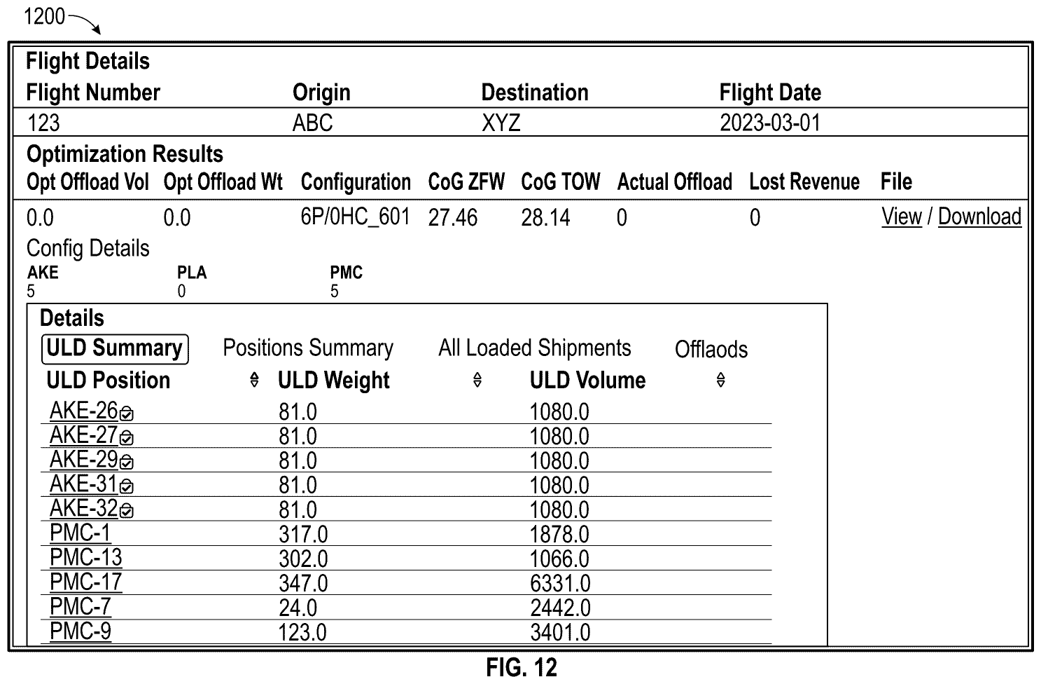

FIG. 12 is a block diagram illustrating a computerized user interface 1200 showing optimization results for cargo load planning for a given aircraft flight and a unit load device (ULD) summary in accordance with one or more embodiments of the present disclosure. The interface 1200 generally shows what pieces of cargo/shipments are planned for specific containers/ULDs and what position they should go in within the aircraft. The interface includes a Download button so that the details of the cargo load plan (e.g., the specific waybills that are assigned to each specific ULD and position within a cargo hold) may be downloaded, printed, etc. Such a downloaded file may be, for example, an Excel file or other data table file.

To view the details of the cargo load plan, the View button may be selected, which causes the Details section of the interface 1200 to be displayed. The interface 1200 further includes an Optimization Results section, which includes information about any cargo/shipments that should be offloaded from the flight (e.g., not shipped in the flight), including an optimized offload volume and an optimized offload weight. The Optimization Results section further includes a configuration for how the ULDs will be organized within the cargo hold (e.g., one of the configurations described herein with respect to FIGS. 3-7). The Optimization Results may further include a center of gravity for ZFW calculation, a center of gravity for TOW calculation, an actual offload amount (e.g., shipments, pieces, weight, etc.), and a lost revenue number associated with offloaded shipments/cargo.

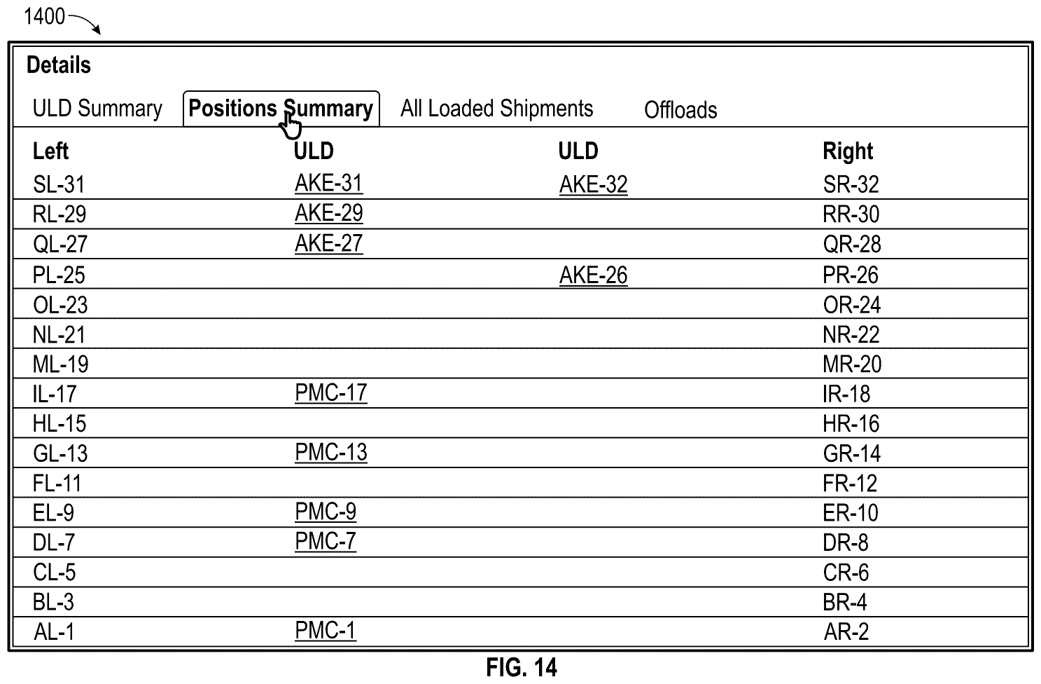

The Optimization Results may further include configuration details, which may include a number of ULDs needed of various types. In the example of the interface 1200, the configuration details indicate that five ULDs of a first type AKE are needed for the flight, zero ULDs of a second type PLA are needed for the flight, and five ULDs of a third type PMC are needed for the flight. The Details section of the interface 1200, which may be toggled on and off by the user pressing the View button, shows four selectable tabs that a user input may select, including ULD Summary, Positions Summary, All Loaded Shipments, and Offloads. The ULD Summary is shown in the interface 1200, and the Positions Summary, All Loaded Shipments, and Offloads tabs are shown selected in FIGS. 14-16, respectively. The ULD Summary includes a ULD Position column that shows a ULD type and a numerical number associated with the position in a cargo plan that the ULD should be loaded into the aircraft. The ULD Summary also includes a ULD Weight column that shows the weight of each ULD used when loaded with the designated cargo/shipments. The ULD Summary also includes a ULD Volume that shows the volume of cargo/shipment within a given ULD per the cargo loading plan.

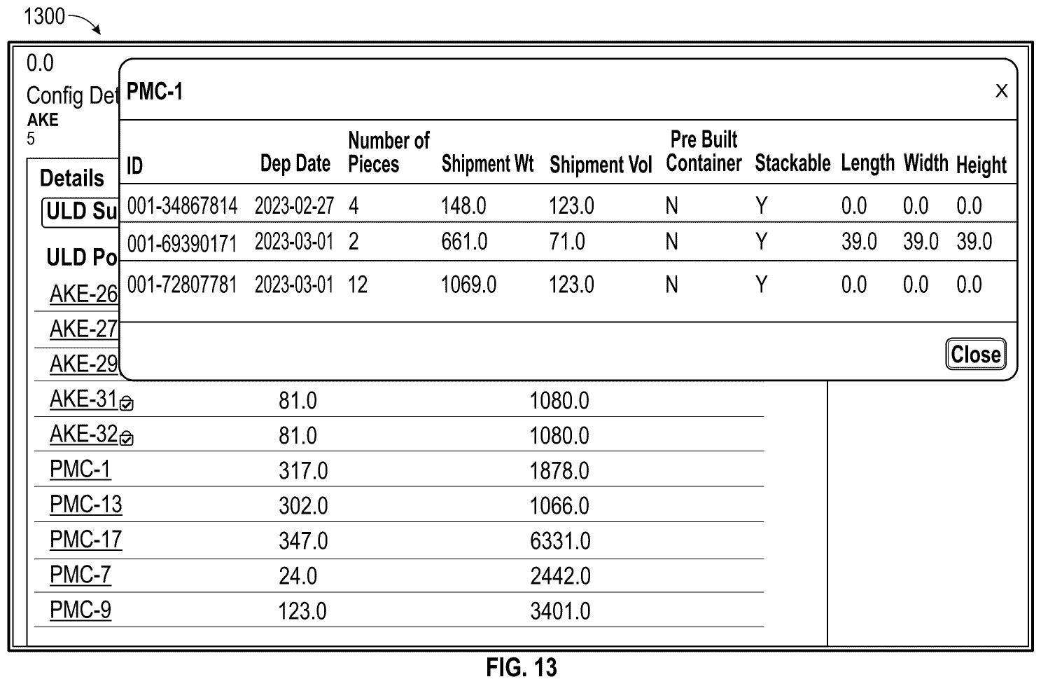

The fields in the ULD Position column of FIG. 12 may be selectable to show more details of the cargo/shipments planned to be loaded in each ULD. FIG. 13 is a block diagram illustrating a computerized user interface 1300 showing detail of cargo shipments to be loaded into an example unit load device (ULD) for a given aircraft flight in accordance with one or more embodiments of the present disclosure. In particular, the interface 1300 shows an example of when a ULD Position field from the interface 1200 of FIG. 12 after a user selects it. In particular, a popup is overlaid over the interface 1200 to yield the interface 1300. The interface 1300 shows when the ULD Position PMC-1 was selected, and shows AWB information for each piece of cargo/shipment that is planned to be loaded into the ULD PMC-1, including an AWB identification number, departure date from its original destination, how many pieces are in the shipment, the shipment weight, the shipment volume, whether the shipment is a pre-built container or ULD, whether each shipment is stackable, and the length/width/height dimensions of each shipment. The user may then input to select the Close button to close the popup overlaid to show ULD details and return from the interface 1300 to the interface 1200.

FIG. 14 is a block diagram illustrating a computerized user interface 1400 showing a position summary for where unit load devices (ULDs) are to be loaded for an example aircraft flight in accordance with one or more embodiments of the present disclosure. The interface 1400 may be shown when the Positions Summary tab from the interface 1200 is selected by the user. The information shown in the interface 1400 may be a data table showing where each planned ULD for the flight is going to be stored according to the cargo load plan, similar to the data tables shown in FIGS. 5 and 7. A load worker may use this tab or information to load ULDs into the proper positions within an aircraft after cargo/shipments have been properly placed in each ULD.

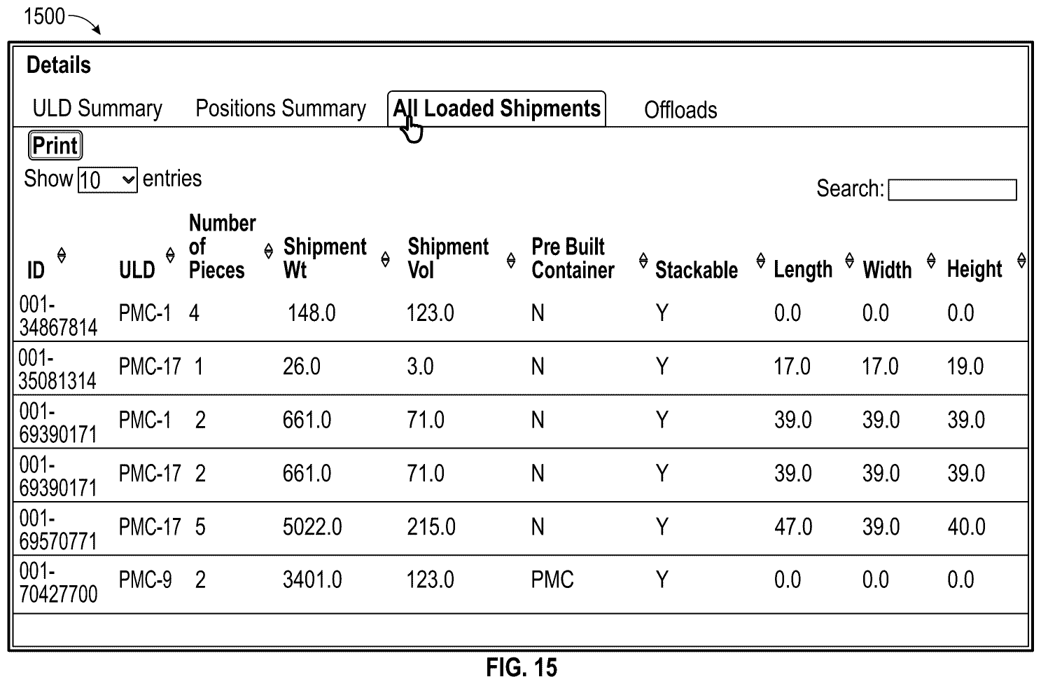

FIG. 15 is a block diagram illustrating a computerized user interface 1500 showing all cargo shipments to be loaded into unit load devices (ULDs) for a given aircraft flight in accordance with one or more embodiments of the present disclosure. The interface 1500 may be shown when the All Loaded Shipments tab from the interface 1200 is selected by the user. The information shown in the interface 1500 includes the detail on each shipment/cargo that is included in the cargo loading plan, including what ULD each shipment/cargo is going into according to the cargo loading plan. A user may use the interface 1500 so search for particular cargo/shipments, may print the list, and/or may sort the data displayed using the different columns shown in the interface 1500.

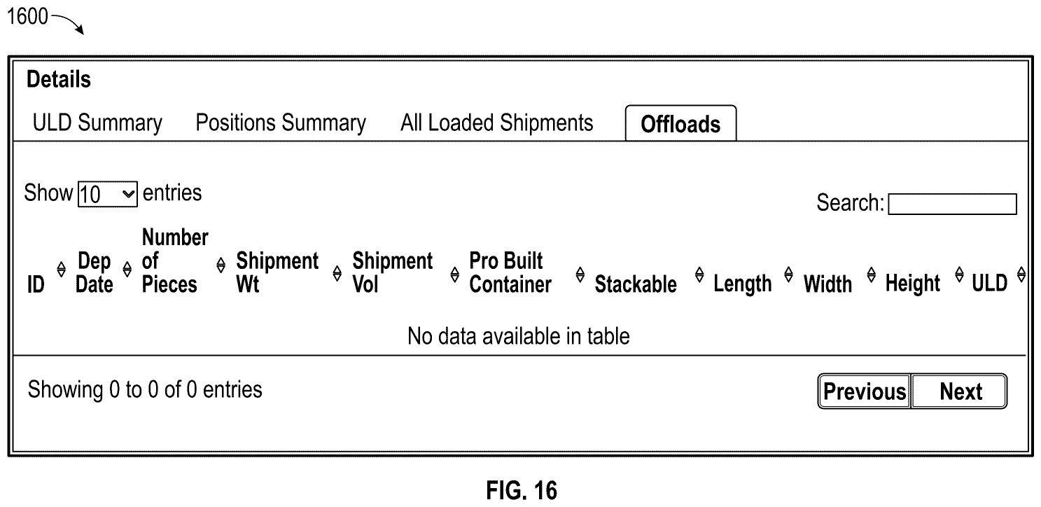

FIG. 16 is a block diagram illustrating a computerized user interface 1600 for showing any cargo shipments to be offloaded or not included in unit load devices (ULDs) for a given aircraft flight in accordance with one or more embodiments of the present disclosure. The interface 1600 may be shown when the Offloads tab from the interface 1200 is selected by the user. The information shown in the interface 1600 may be similar to that shown in the interface 1500 when there is cargo/shipments offloaded. That is, while no information is shown in the example of the interface 1500, whenever cargo/shipments are offloaded, detail about those shipments similar to the cargo/shipment detail shown in the interface 1500 (except a designated ULD to load the cargo/shipment into) may be shown in the interface 1600, so a user can readily see any cargo/shipment that should be set aside as being offloaded so the load worker does not accidentally load such cargo into a ULD.

As such, described herein are various methods, systems, computer readable media configured for storage on a memory and execution by a processor of a computer device, etc. for implementing improved cargo load planning for aircraft.

In various embodiments, different aspects are described with respect to FIGS. 17 and 18 that are described in further detail below. Any combination of the various computing components and aspects of FIGS. 17 and 18 may be used in the various embodiments described herein. For example, users of a cargo load planning system may use any of client devices 102, 103, 104, or 202a through 202n to interact with various other computer devices as described herein to perform cargo load planning. In other words, the client devices 102, 103, 104, and/or 202a through 202n may be, may be similar to, or may perform similar functions to any of the cargo load planning user device 155, the load worker computing device 175, and/or the cargo customer device 170 of FIG. 1 as described herein. As another example, server devices, such as cloud-based servers or otherwise, of a cargo load planning system may be any or all of server devices 106/107/204/213 and/or one or more cloud components 225 that may utilize network databases or electronic storage in the memories 216/217, the databases 207/215, and/or the one or more cloud components 225. In other words, the devices 106, 107, 204, 207, 213, 215, 216, 217, and/or 225 may be, may be similar to, or may perform similar functions to any of the cargo management system server device 165 and/or the cargo load planning server device 160 of FIG. 1 as described herein. Similarly, the networks 105 and/or 206 may be, may be similar to, or may perform similar functions to the network 180 of FIG. 1 as described herein.

The client devices 102, 103, 104, or 202a through 202n may communicate with server devices 106, 107, 204, or 213; network databases 207 or 215; and/or one or more cloud components 225 through the networks 105 or 206. In various embodiments, the components of FIGS. 17 and 18 may additionally or alternatively be used to implement or execute the methods or processes described herein. In any event, one or more of the computing devices, systems, etc. may be in communication with any or all of the other devices shown in FIGS. 17 and 18 to implement the systems and methods described herein. The components shown in FIGS. 17 and 18 are described in greater detail below.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems/platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

FIG. 17 is a block diagram depicting a computer-based system and platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 100 may be configured to manage a large number of members and/or concurrent transactions, as detailed herein. In some embodiments, the exemplary computer-based system/platform 100 may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 17, members 102-104 (e.g., clients) of the exemplary computer-based system/platform 100 may include virtually any computing device capable of receiving and sending a message over a network (e.g., cloud network), such as network 105, to and from another computing device, such as servers 106 and 107, each other, and the like. In some embodiments, the member devices 102-104 may be personal computers, multiprocessor systems, microprocessor-based or programmable consumer electronics, network PCs, and the like. In some embodiments, one or more member devices within member devices 102-104 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 102-104 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 102-104 may include may run one or more applications, such as Internet browsers, mobile applications, voice calls, video games, videoconferencing, and email, among others. In some embodiments, one or more member devices within member devices 102-104 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 102-104 may be specifically programmed by either Java, .Net, QT, C, C++ and/or other suitable programming language. In some embodiments, one or more member devices within member devices 102-104 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 105 may provide network access, data transport and/or other services to any computing device coupled to it. In some embodiments, the exemplary network 105 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 105 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 105 may include and implement, as an alternative or in conjunction with one or more of the above, a WiMAX architecture defined by the WiMAX forum. In some embodiments and, optionally, in combination of any embodiment described above or below, the exemplary network 105 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 105 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 105 may also include mass storage, such as network attached storage (NAS), a storage area network (SAN), a content delivery network (CDN) or other forms of computer or machine readable media.

In some embodiments, the exemplary server 106 or the exemplary server 107 may be a web server (or a series of servers) running a network operating system, examples of which may include but are not limited to Microsoft Windows Server, Novell NetWare, or Linux. In some embodiments, the exemplary server 106 or the exemplary server 107 may be used for and/or provide cloud and/or network computing. Although not shown in FIG. 17, in some embodiments, the exemplary server 106 or the exemplary server 107 may have connections to external systems like email, SMS messaging, text messaging, ad content providers, etc. Any of the features of the exemplary server 106 may be also implemented in the exemplary server 107 and vice versa.

In some embodiments, one or more of the exemplary servers 106 and 107 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 101-104.

In some embodiments and, optionally, in combination of any embodiment described above or below, for example, one or more exemplary computing member devices 102-104, the exemplary server 106, and/or the exemplary server 107 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

FIG. 18 depicts a block diagram of another exemplary computer-based system/platform 200 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 202a, 202b through 202n shown each at least includes a computer-readable medium, such as a random-access memory (RAM) 208 coupled to a processor 210 or FLASH memory. In some embodiments, the processor 210 may execute computer-executable program instructions stored in memory 208. In some embodiments, the processor 210 may include a microprocessor, an ASIC, and/or a state machine. In some embodiments, the processor 210 may include, or may be in communication with, media, for example computer-readable media, which stores instructions that, when executed by the processor 210, may cause the processor 210 to perform one or more steps described herein. In some embodiments, examples of computer-readable media may include, but are not limited to, an electronic, optical, magnetic, or other storage or transmission device capable of providing a processor, such as the processor 210 of client 202a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 202a through 202n may also comprise a number of external or internal devices such as a mouse, a CD-ROM, DVD, a physical or virtual keyboard, a display, or other input or output devices. In some embodiments, examples of member computing devices 202a through 202n (e.g., clients) may be any type of processor-based platforms that are connected to a network 206 such as, without limitation, personal computers, digital assistants, personal digital assistants, smart phones, pagers, digital tablets, laptop computers, Internet appliances, and other processor-based devices. In some embodiments, member computing devices 202a through 202n may be specifically programmed with one or more application programs in accordance with one or more principles/methodologies detailed herein. In some embodiments, member computing devices 202a through 202n may operate on any operating system capable of supporting a browser or browser-enabled application, such as Microsoft™ Windows™, and/or Linux. In some embodiments, member computing devices 202a through 202n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 202a through 202n, users 212a through 212n, may communicate over the exemplary network 206 with each other and/or with other systems and/or devices coupled to the network 206. As shown in FIG. 18, exemplary server devices 204 and 213 may be also coupled to the network 206. In some embodiments, one or more member computing devices 202a through 202n may be mobile clients.

In some embodiments, at least one database of exemplary databases 207 and 215 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

As also shown in FIG. 18, some embodiments of the disclosed technology may also include and/or involve one or more cloud components 225, which are shown grouped together in the drawing for sake of illustration, though may be distributed in various ways as known in the art. Cloud components 225 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS), platform as a service (PaaS), and/or software as a service (SaaS).

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components and cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux™, (2) Microsoft Windows™, (3) OS X (Mac OS), (4) Solaris™, (5) UNIX™ (6) VMWare™, (7) Android™, (8) Java Platforms™, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™ Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A method comprising:
receiving, by a processor of a computing device, first data indicative of a plurality of predetermined configurations for loading cargo into a compartment of a cargo hold of an aircraft, wherein each of the plurality of predetermined configurations comprises a possible layout of a plurality of unit load devices, wherein the plurality of unit load devices comprises at least two different types of unit load devices;
receiving, by the processor, second data indicative of a plurality of shipments available for transportation in the aircraft, wherein each one of the plurality of shipments is:
pre-packaged into a first unit load device type of the at least two different types of unit load devices, or
configured for placement into a second unit load device type of the at least two different types of unit load devices;
determining, by the processor, a plurality of possible shipping configurations from the plurality of predetermined configurations, each one of the plurality of possible shipping configurations comprising:
a recommended assignment of each of the plurality of shipments into or as one of the plurality of unit load devices, and
a recommended location of each of the plurality of unit load devices within the cargo hold of the aircraft according to the possible layout of each of the plurality of possible shipping configurations; and
determining, by the processor based on at least one rule related to weight balancing of the aircraft, one of the plurality of possible shipping configurations that satisfies the at least one rule.

2. The method of claim 1, further comprising sending, by the processor to a computing device associated with an aircraft load worker, the one of the plurality of possible shipping configurations that satisfies the at least one rule.

3. The method of claim 1, wherein the at least one rule related to weight balancing of the aircraft comprises a first requirement that a first center of gravity for a takeoff weight of the aircraft is within a first predetermined range and a second requirement that a second center of gravity for a zero fuel weight of the aircraft is within a second predetermined range.

4. The method of claim 1, wherein the at least one rule related to weight balancing of the aircraft comprises a requirement that a first unit load device of the plurality of unit load devices having a high priority level is included in the one of the plurality of possible shipping configurations, wherein a second unit load device of the plurality of unit load devices having a low priority is optionally included in the one of the plurality of possible shipping configurations.

5. The method of claim 1, wherein the at least one rule related to weight balancing of the aircraft comprises a requirement that a total weight of the plurality of shipments in the plurality of unit load devices of the one of the plurality of possible shipping configurations is at or less than a total permitted weight of the compartment.

6. The method of claim 1, wherein the compartment is a first compartment, wherein the aircraft further comprises a second compartment of the cargo hold, and wherein the at least one rule related to weight balancing of the aircraft comprises a requirement that:
a first total weight of a first subset of the plurality of shipments in the plurality of unit load devices of the one of the plurality of possible shipping configurations for the first compartment is at or less than a first total permitted weight of the first compartment; and
a second total weight of a second subset of the plurality of shipments of the plurality of unit load devices of the one of the plurality of possible shipping configurations for the second compartment is at or less than a second total permitted weight of the second compartment.

7. The method of claim 1, wherein the at least one rule related to weight balancing of the aircraft comprises a requirement that the plurality of unit load devices fit in the compartment of the cargo hold.

8. The method of claim 1, wherein the at least one rule related to weight balancing of the aircraft comprises a requirement that a weight balance of the aircraft is within a predetermined range based on each of the one of the plurality of possible shipping configurations, an estimated weight of passengers on a flight, and an estimated weight of passenger checked bags for the flight.

9. The method of claim 1, wherein the at least one rule related to weight balancing of the aircraft comprises a requirement, for the recommended assignment of each of the plurality of shipments into one of the plurality of unit load devices, that each of the plurality of shipments that are configured for placement into the second load device type fit into a respective unit load device of the plurality of unit load devices that are of the second load device type.

10. The method of claim 1, wherein the receiving of the second data indicative of the plurality of shipments available for transportation in the aircraft occurs at least a predetermined amount of time before a scheduled flight.

11. The method of claim 10, wherein the predetermined amount of time is approximately one hour, approximately two hours, approximately three hours, or approximately four hours before the scheduled flight.

12. The method of claim 1, wherein the determining that the one of the plurality of possible shipping configurations satisfies the at least one rule comprises determining that at least one of the plurality of shipments will not be loaded onto a given scheduled flight of the aircraft.

13. The method of claim 12, further comprising sending, by the processor to a computing device associated with an aircraft load worker, the one of the plurality of possible shipping configurations that satisfies the at least one rule, wherein the one of the plurality of possible shipping configurations is sent to the computing device before any of the plurality of shipments are loaded onto the aircraft in advance of the given scheduled flight.

14. The method of claim 1, further comprising receiving, by the processor, an input from a user via a user interface, wherein the input indicates whether one of the plurality of shipments is stackable.

15. The method of claim 1, further comprising receiving, by the processor, an input from a user via a user interface, wherein the input indicates whether one of the plurality of shipments is a priority shipment.

16. A non-transitory computer readable medium having instructions stored thereon that, upon execution by a computing device, cause the computing device to perform operations comprising:
receiving first data indicative of a plurality of predetermined configurations for loading cargo into a compartment of a cargo hold of an aircraft, wherein each of the plurality of predetermined configurations comprises a possible layout of a plurality of unit load devices, wherein the plurality of unit load devices comprises at least two different types of unit load devices;
receiving second data indicative of a plurality of shipments available for transportation in the aircraft, wherein each one of the plurality of shipments is:
pre-packaged into a first unit load device type of the at least two different types of unit load devices, or
configured for placement into a second unit load device type of the at least two different types of unit load devices;
determining a plurality of possible shipping configurations from the plurality of predetermined configurations, each one of the plurality of possible shipping configurations comprising:
a recommended assignment of each of the plurality of shipments into or as one of the plurality of unit load devices, and
a recommended location of each of the plurality of unit load devices within the cargo hold of the aircraft according to the possible layout of each of the plurality of possible shipping configurations; and
determining, based on at least one rule related to weight balancing of the aircraft, one of the plurality of possible shipping configurations that satisfies the at least one rule.

17. The non-transitory computer readable medium of claim 16, wherein the instructions further cause the computing device to perform operations comprising sending, to a display of a user computing device, the one of the plurality of possible shipping configurations that satisfies the at least one rule, wherein the display is configured to display instructions for loading the plurality of shipments into the cargo hold of the aircraft.

18. The non-transitory computer readable medium of claim 17, wherein the instructions for loading the plurality of shipments into the cargo hold of the aircraft comprises a position indicator for a position in the cargo hold where each of the unit load devices that will be loaded into the cargo hold will be placed.

19. The non-transitory computer readable medium of claim 17, wherein the instructions for loading the plurality of shipments into the cargo hold of the aircraft comprises an instruction to load particular shipments of the plurality of shipments into a particular unit load device that will be loaded into the cargo hold.

20. A system comprising:
a memory; and
at least one processor coupled to the memory, the at least one processor configured to:
receive first data indicative of a plurality of predetermined configurations for loading cargo into a compartment of a cargo hold of an aircraft, wherein each of the plurality of predetermined configurations comprises a possible layout of a plurality of unit load devices;
receive second data indicative of a plurality of shipments available for transportation in the aircraft, wherein each one of the plurality of shipments is: pre-packaged into one of the plurality of unit load devices, or configured for placement into one of the plurality of unit load devices;
determine a plurality of possible shipping configurations from the plurality of predetermined configurations, each one of the plurality of possible shipping configurations comprising:
a recommended assignment of each of the plurality of shipments into one of the plurality of unit load devices, and
a recommended location of each of the plurality of unit load devices within the cargo hold of the aircraft according to the possible layout of each of the plurality of possible shipping configurations; and
determine, based on at least one rule related to weight balancing of the aircraft, one of the plurality of possible shipping configurations that satisfies the at least one rule.
